(19) United States
(12) Patent Application Publication
(10) Pub. No.: US 2024/0411646 A1
(43) Pub. Date: Dec. 12, 2024

(54) REVERSE OPERATION FOR SNAPSHOT CHAINS WITH INLINE CONSOLIDATION AND GARBAGE COLLECTION

(71) Applicant: Rubrik, Inc., Palo Alto, CA (US)

(72) Inventor: Harmandeep Singh, Bengaluru (IN)

(21) Appl. No.: 18/207,492

(22) Filed: Jun. 8, 2023

(51) Int. Cl. G06F 11/14; G06F 16/25; G06F 16/27

(52) U.S. Cl. CPC G06F 11/1451; G06F 16/258; G06F 16/27; G06F 2201/84

(57) ABSTRACT

Methods, systems, and devices for data management are described. A snapshot chain may include a full snapshot of a data block and incremental snapshots including changes to partitions of the data block since the full snapshot. A snapshot in the snapshot chain may be marked for deletion. A data management system (DMS) may perform an operation to convert a most recent incremental snapshot to a full snapshot. As part of the operation, the DMS may write, from snapshots in the snapshot chain that include data in different partitions of the data block, the data to more recent snapshots that satisfy conditions. The conditions may include the more recent snapshot not being marked for deletion and being a most recent snapshot in the snapshot chain that has an empty data set in the respective partition. As part of the operation, the DMS may delete snapshots that are marked for deletion.

### FIELD OF TECHNOLOGY

The present disclosure relates generally to data management, including techniques for reverse operation for snapshot chains with inline consolidation and garbage collection.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports reverse operation for snapshot chains with inline consolidation and garbage collection in accordance with aspects of the present disclosure.

FIG. 2 shows an example of a computing environment architecture that supports reverse operation for snapshot chains with inline consolidation and garbage collection in accordance with aspects of the present disclosure.

FIG. 3 shows examples of snapshot chain reverse, consolidation, and garbage collection operations that support reverse operation for snapshot chains with inline consolidation and garbage collection in accordance with aspects of the present disclosure.

FIG. 4 shows an example of a inline snapshot chain reverse operation that supports reverse operation for snapshot chains with inline consolidation and garbage collection in accordance with aspects of the present disclosure.

FIG. 5 shows an example of a inline snapshot chain reverse operation that supports reverse operation for snapshot chains with inline consolidation and garbage collection in accordance with aspects of the present disclosure.

FIG. 6 shows an example of a process flow that supports reverse operation for snapshot chains with inline consolidation and garbage collection in accordance with aspects of the present disclosure.

FIGS. 7 and 8 show block diagrams of devices that support reverse operation for snapshot chains with inline consolidation and garbage collection in accordance with aspects of the present disclosure.

FIG. 9 shows a block diagram of a reverse operation manager that supports reverse operation for snapshot chains with inline consolidation and garbage collection in accordance with aspects of the present disclosure.

FIG. 10 shows a diagram of a system including a device that supports reverse operation for snapshot chains with inline consolidation and garbage collection in accordance with aspects of the present disclosure.

FIGS. 11 through 13 show flowcharts illustrating methods that support reverse operation for snapshot chains with inline consolidation and garbage collection in accordance with aspects of the present disclosure.

### DETAILED DESCRIPTION

A data management system (DMS) may manage backup and restoration of data for one or more customers. To back up a data block, the DMS may, in some examples, obtain a full snapshot of the data block at a first time. The full snapshot may include data associated with each partition of the data block (e.g., all data stored in the data block at the first time). The DMS may subsequently obtain incremental snapshots that store data associated with changes to any of the partitions of the data block since the first time. The incremental snapshots may include empty data sets in any partition that did not change since the first time. The DMS may store the full snapshot and subsequent incremental snapshots as a snapshot chain, where each incremental snapshot depends from the full snapshot and the other snapshots that were obtained before the incremental snapshot. To reduce latency associated with recovering a point-in-time version of the data, the DMS may perform a reverse operation to shuffle the order of data in the snapshot chain. The reverse operation may convert a most recently obtained incremental snapshot in the snapshot chain to a full snapshot that includes the most recent data associated with each partition of the data block. However, if at least one of the snapshots in the chain is expired (e.g., has been marked for deletion by a user), such a reverse operation may be associated with multiple read and write operations, including write operations to the expired snapshot.

Techniques, systems, and devices described herein provide for a DMS to perform inline garbage collection and consolidation while performing a reverse operation. The described reverse operation techniques may improve efficiency and reduce processing for reversing an order of a snapshot chain. For example, as part of the reverse operation, the DMS may perform write operations to move data from the full snapshot or other earlier incremental snapshots in the snapshot chain to more recent snapshots in the snapshot chain that satisfy a set of conditions. The conditions may be that the more recent snapshots to which data is to be moved are not marked for deletion by a user (e.g., are non-expired snapshots) and include an empty data set in the respective partition associated with the data to be moved. For example, if the full snapshot includes data associated with a first partition of the data block, and all other snapshots in the snapshot chain include an empty data set in the first partition, then the DMS may write the data from the full snapshot to a most recent snapshot in the snapshot chain that is not expired. The DMS may repeat such writing until the most recent non-expired snapshot in the snapshot chain includes data associated with each partition and thereby becomes a full snapshot. By performing such writing conditionally, the DMS may refrain from writing to any expired snapshots. As such, the DMS may refrain from generating a patch file for an expired snapshot, which may reduce latency and processing.

Additionally, as part of the reverse operation, the DMS may perform inline consolidation and garbage collection. That is, the DMS may execute a single operation that may reverse an order of the snapshot chain, consolidate data in the snapshot chain, and delete any expired data in the snapshot chain. For example, the DMS may consolidate, as part of the reverse operation, any data in an expired snapshot with data in a snapshot prior to the expired snapshot in the snapshot chain after the reverse operation. That is, the DMS may write any data from the expired snapshot to the prior snapshot if there is an empty data set in a corresponding partition in the prior snapshot. Otherwise, the DMS may maintain the expired data in the expired snapshot. The DMS may delete, as part of the reverse operation, any data partitions that are marked for expiration. The DMS may thereby refrain from performing separate operations to consolidate data and garbage collect data after reversing the snapshot chain, which may reduce latency and improve storage capacity as compared with systems in which the DMS reverses the snapshot chain and then waits for a next garbage collection operation to remove any expired data.

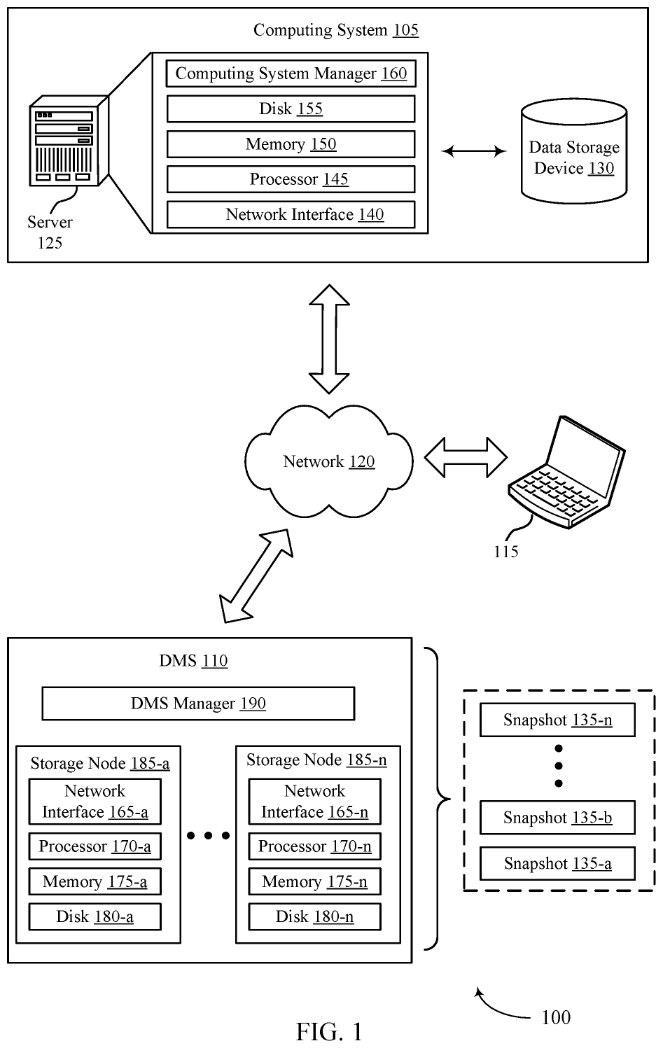

FIG. 1 illustrates an example of a computing environment 100 that supports reverse operation for snapshot chains with inline consolidation and garbage collection in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150) and executed by the processor 145) to perform functions ascribed herein to the computing system 105. In some examples, the network interface 140, processor 145, memory 150), and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below:

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110 may back up a data block or some other type of computing resource for a customer. For example, the DMS 110 may obtain snapshots 135 over time of the data block. The DMS 110 may store the snapshots 135 in the form of a snapshot chain, with a first snapshot 135 in the chain being a full snapshot of the data block and remaining snapshots 135 in the chain being incremental snapshots that show changes to partitions of the data block since the full snapshot 135 was obtained. The incremental snapshots 135 may include empty data sets in any partition that did not change since the first time at which the full snapshot 135 was obtained. Each incremental snapshot 135 in the snapshot chain may depend from the full snapshot 135 and the other snapshots 135 that were obtained before the incremental snapshot 135. To recover a point-in-time version of the data block, the DMS 110 may need to access an incremental snapshot 135 associated with the point-in-time and all snapshots 135 in the snapshot chain 135 from which the incremental snapshot 135 depends. If the snapshot chain is relatively long, such recovery processes may be associated with relatively high latency. I/O operations, and processing. To reduce latency associated with recovering a point-in-time version of the data block, the DMS 110 may perform a reverse operation to shuffle the order of data in the snapshot chain. The reverse operation may convert a most recently obtained incremental snapshot 135 in the snapshot chain to a full snapshot 135 that includes the most recent data associated with each partition of the data block. However, if at least one of the snapshots 135 in the chain is expired (e.g., has been marked for deletion by a user), such a reverse operation may be associated with multiple read and write operations, including write operations to the expired snapshot 135.

As described herein, the DMS 110 may improve efficiency and reduce processing for reversing an order of a snapshot chain by performing consolidation and garbage collection inline as part of the reverse operation. For example, as part of the reverse operation, the DMS 110 may perform write operations to move data from the full snapshot 135 or other earlier incremental snapshots 135 in the snapshot chain to more recent snapshots 135 in the snapshot chain that satisfy a set of conditions. The conditions may be that the more recent snapshots 135 to which data is to be moved are not marked for deletion by a user (e.g., are non-expired snapshots) and include an empty data set in the respective partition associated with the data to be moved. For example, if the full snapshot 135 includes data associated with a first partition of the data block, and all other snapshots 135 in the snapshot chain include an empty data set in the first partition, then the DMS 110 may write the data from the full snapshot 135 to a most recent snapshot 135 in the snapshot chain that is not expired. The DMS 110 may repeat such writing until the most recent non-expired snapshot 135 in the snapshot chain includes data associated with each partition and thereby becomes a full snapshot 135. By performing such writing conditionally, the DMS 110 may refrain from writing to any expired snapshots 135. As such, the DMS 110 may refrain from generating a patch file for an expired snapshot 135, which may reduce latency and processing.

Additionally, as part of the reverse operation, the DMS 110 may perform inline consolidation and garbage collection. That is, the DMS 110 may execute a single operation that may reverse an order of the snapshot chain, consolidate data in the snapshot chain, and delete any expired data in the snapshot chain. For example, the DMS 110 may consolidate, as part of the reverse operation, any data in an expired snapshot 135 with data in a snapshot 135 prior to the expired snapshot 135 in the snapshot chain after the reverse operation. That is, the DMS 110 may write any data from the expired snapshot 135 to the prior snapshot 135 if there is an empty data set in a corresponding partition in the prior snapshot 135. Otherwise, the DMS 110 may maintain the expired data in the expired snapshot 135. The DMS 110 may delete, as part of the reverse operation, any data partitions that are marked for expiration. The DMS 110 may thereby refrain from performing separate operations to consolidate data and garbage collect data after reversing the snapshot chain, which may reduce latency and improve storage capacity as compared with systems in which the DMS 110 reverses the snapshot chain and then waits for a next garbage collection operation to remove any expired data.

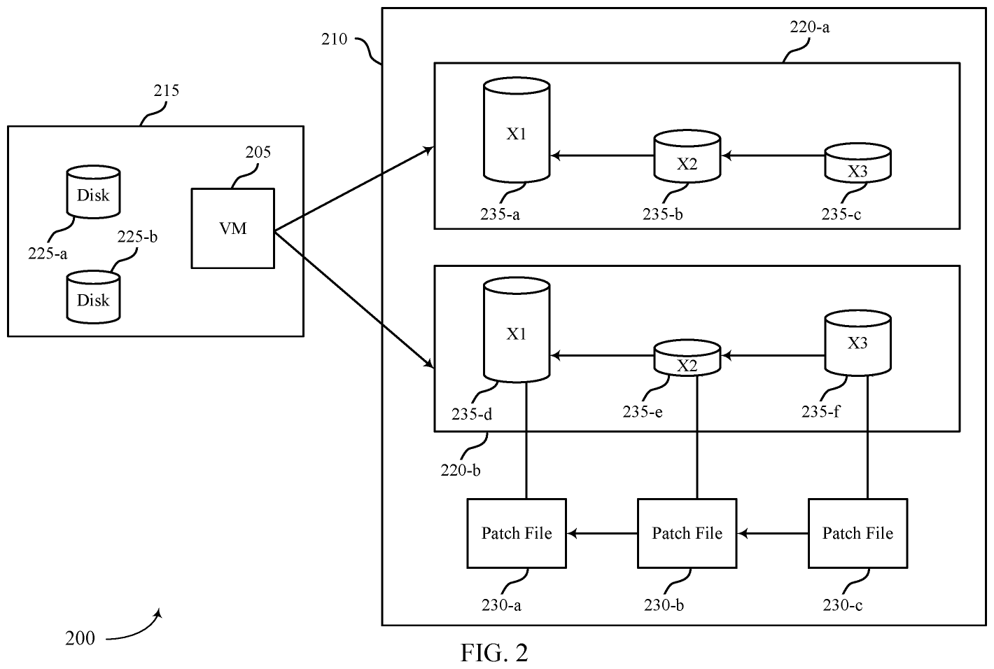

FIG. 2 shows an example of a computing environment architecture 200 that supports reverse operation for snapshot chains with inline consolidation and garbage collection in accordance with aspects of the present disclosure. The computing environment architecture 200 may implement or be implemented by aspects of the computing environment 100 described with reference to FIG. 1. For example, the computing environment architecture 200 may include a computing device 215 and a DMS 210, which may represent examples of a computing device 115 an a DMS 110 as described with reference to FIG. 1. A client may access or communicate with the DMS 110 via the computing device 215 and a user interface. The DMS 210 may include a snapshot storage location (e.g., a database or cluster) that may store backups of client data from the computing device. In this example, the DMS may obtain and store one or more snapshot chains 220 that back up data for one or more disks 225 of the computing device 215.

The DMS may manage backup and recovery of data for one or more computing devices 215 of one or more clients. The computing device 215 may include or be associated with various hardware components and corresponding computing resources, such as a VM 205, which may include one or more disks 225 (e.g., the disks 225-a and 225-b in this example). The DMS 210 may backup the computing device 215 by writing data that represents a version of the computing device 215 at a given point-in-time to the snapshot storage location of the DMS 210. The DMS 210 may obtain multiple backups of the computing device 215 over time, such that the client may recover the computing device 215 to any one of the multiple backed up versions. The DMS 210 may obtain and store backups of each disk 225 of the VM 205, or on some other level of granularity, such as per data block or per some other type of computing object.

To improve storage consumption as described herein, the DMS 210 may obtain snapshots of a computing object using incremental snapshot techniques. For example, the DMS 210 may obtain a first full snapshot 235 (e.g., the full snapshots 235-a and 235-d in FIG. 2) at a first point-in-time. The full snapshot 235 may also be referred to as a base snapshot in some examples herein. As described in further detail with reference to FIG. 1, a full snapshot 235 may represent the entirety of the state of the corresponding computing object as of the first time at which the full snapshot 235 is obtained. At subsequent times, when backing up the same device, the DMS 210 may obtain incremental snapshots 235. An incremental snapshot 235 may represent the changes to the state—which may be referred to as the delta—of the corresponding computing object that have occurred between an earlier or later point in time corresponding to another snapshot 235 (e.g., another full snapshot 235 or incremental snapshot 235) of the computing object and the incremental snapshot 235.

The DMS 210 may store the incremental snapshots 235 and full snapshots 235 for a computing object in the form of a snapshot chain 220. In the example of FIG. 2, the snapshot chain 220-a may be associated with (e.g., may represent or store data from) the disk 225-a and the snapshot chain 220-b may be associated with (e.g., may represent or store data from) the disk 225-b. A snapshot chain may include at least one full snapshot 235 and one or more incremental snapshots 235 that depend from the full snapshot 235. For example, the one or more incremental snapshots 235-b and 235-c may be obtained after the full snapshot 235-a in time and may include changes to the computing object that have occurred since the first time associated with the full snapshot 235-a. To recover a computing object to a given point in time, the DMS 210 may read the snapshot chain 220 and combine the incremental snapshot 235 associated with the requested recovery time with other incremental and full snapshots 235 from which the incremental snapshot 235 depends in the snapshot chain 220 to generate a version of the computing object at the requested recovery time. For example, to recover the disk 225-b at the third point in time, the DMS 210 may read the data in the snapshot 235-f, the data in the snapshot 235-e, and the data in the snapshot 235-d. The DMS 210 may combine the data to recover the version of the disks 225-b at the third time at which the snapshot 235-f was obtained.

In some examples, the snapshots 235 may be mapped to or stored as one or more patch files 230. For example, the DMS 210 may generate one or more patch files 230 for each snapshot 235. A patch file 230 may represent a sparse file stored in a file system, such as a distributed file system, that contains changes to be applied to another file or files. In some examples, a patch file 230 may be implemented as a key-value store. For example, a patch file 230 may store data partitions that have changed since a most recent snapshot 235 was obtained, as well as offsets to the data partitions. The snapshot chain 220-b may be stored as a set of patch files 230-a, 230-b, and 230-c in a distributed file system, for example. The patch file 230-b for the incremental snapshot 235-e may store one or more data partitions (e.g., a data block or portion of a data block of the disk 225-b) and offsets to each of the one or more data partitions in the patch file 230-b. Other data partitions in the patch file 230-b may be null (e.g., may include empty data sets).

In some examples, reversing an order of a snapshot chain 220 may be beneficial. For example, a reverse operation may reshuffle data between snapshots to make a latest or most recent snapshot 235 (e.g., backup) a full snapshot 235. Such reversing of a snapshot chain may increase recovery performance by allowing recovery of more recent snapshots 235 in the snapshot chain 220 using fewer read operations than if the snapshot chain 220 is not reversed.

The DMS 210 may execute a reverse operation periodically or based on one or more conditions. For example, if a length (e.g., a quantity of snapshots 235) of the snapshot chain 220 exceeds a threshold length (e.g., 64 snapshots 235, or some other threshold), the DMS 210 may initiate the reverse operation. Additionally, or alternatively, the DMS 210 may initiate the reverse operation based on a change rate associated with the snapshot chain 220 exceeding a threshold change rate (e.g., a 50 percent change rate, or some other threshold). The change rate may correspond to an amount of data that is changed between subsequent consecutive snapshots (e.g., a data change delta). The threshold length, the threshold change rate, or both may be configured by the DMS 210, the client, a system administrator, or any combination thereof.

In some examples, a client device, such as the computing device 215, may transmit a request to the DMS 210 to delete one or more snapshots 235. In response to the request, the DMS 210 may mark the one or more snapshots 235 for deletion and may delete (e.g., garbage collect) the one or more snapshots 235 during a next garbage collection operation. A snapshot 235 that is marked for deletion may be referred to as an expired snapshot in some examples herein. A client may request to delete a snapshot 235 (e.g., mark a snapshot 235 as expired) periodically, in some examples. For example, the client may store weekly snapshots, monthly snapshots, or snapshots 235 on some other periodic basis. If the DMS 210 obtains snapshots 235 more frequently, the client may request to delete remaining snapshots 235. Additionally, or alternatively, the client may monitor a length of the snapshot chains 220 and may request to delete one or more snapshots 235 to conserve storage space if the length is relatively long (e.g., greater than a threshold). In some examples, the client may request to delete snapshots 235 that were obtained before a given time (e.g., relatively old snapshots 235). The snapshots that are marked for deletion may be full snapshots 235, incremental snapshots 235, or both.

If one or more snapshots 235 in the snapshot chain 220 depend from the snapshot 235 that the client wishes to delete, the one or more dependent snapshots 235 may not be recoverable if the snapshot 235 is deleted or removed from the snapshot chain 220. Accordingly, the DMS 210 may perform a consolidation operation to consolidate the data in the expired snapshot 235 with data in a next unexpired snapshot 235 in the snapshot chain 220. For example, if the snapshot 235-b is expired (e.g., X2), the DMS 210 may consolidate the snapshot 235-b with the next unexpired snapshot in the snapshot chain 220-a, which may be the snapshot 235-c (e.g., X3). The DMS 210 may subsequently garbage collect the expired snapshot.

In some cases, if the DMS 210 performs a reverse operation separately from consolidation and garbage collection operations, the DMS 210 may write data to the expired snapshots 235 during the reverse operation. The DMS 210 may generate a patch file for each of the expired snapshots 235 and the other snapshots 235 in the snapshot chain 220 to support such writes. Patch file generation may be associated with relatively high processing and I/O.

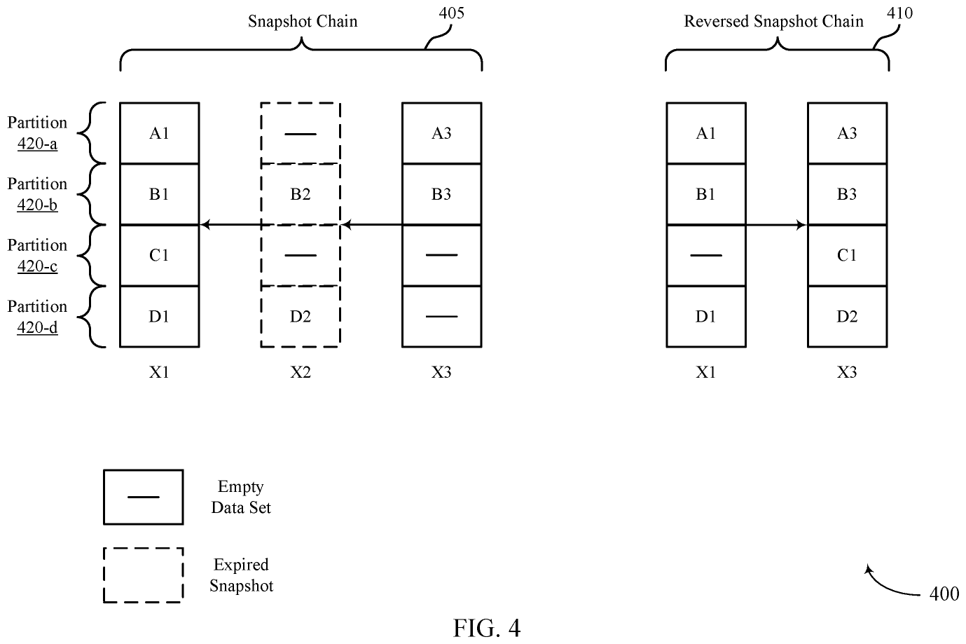

Techniques, systems, and devices described herein provide for a DMS 210 to perform consolidation and garbage collection inline as part of a reverse operation. The DMS 210 may refrain from or skip writing to any expired snapshots 235 during the reverse operation. For example, if the snapshot 235-e is expired, the DMS 210 may refrain from creating the corresponding patch file 230-b and may instead conditionally write data between the other snapshots 235 in the snapshot chain 220-b that are not expired. The DMS 210 may perform conditional writing to reverse the order of the snapshot chain 220 with reduced processing and complexity. The described techniques may thereby provide for improved reverse operation performance, increased storage capacity, reduced latency, and reduced processing, among other possibilities. Techniques for performing such enhanced inline reverse operations are described in further detail elsewhere herein, including with reference to FIGS. 4-6.

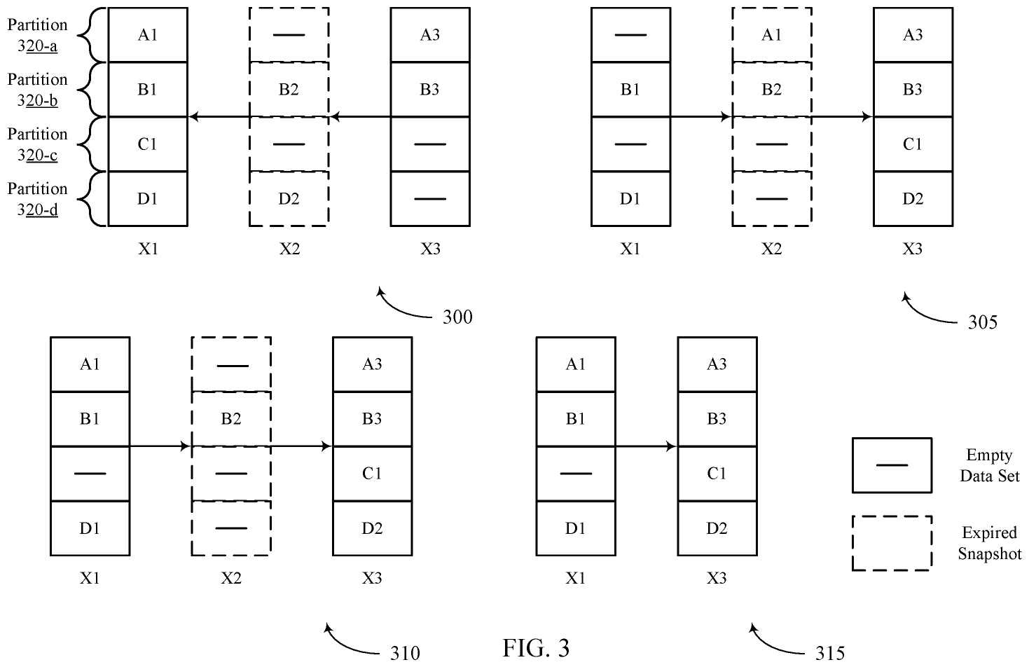

FIG. 3 shows examples of snapshot chain reverse, consolidation, and garbage collection operations that support reverse operation for snapshot chains with inline consolidation and garbage collection in accordance with aspects of the present disclosure. The snapshot chain reverse, consolidation, and garbage collection operations may implement or be implemented by aspects of the computing environment 100 and the computing environment architecture 200, as described with reference to FIGS. 1 and 2. For example, the snapshot chain reverse, consolidation, and garbage collection operations illustrates a reverse operation, a consolidation operation, and a garbage collection operation for a snapshot chain that includes snapshots X1, X2, and X3, which may represent examples of the snapshots 135 and 235 described with reference to FIGS. 1 and 2. In this example, the incremental snapshot X2 may be an expired snapshot, and the DMS may reverse the snapshot chain before subsequently performing a consolidation operation and later garbage collecting any expired data.

At 300, the DMS may obtain and store a snapshot chain including three snapshots. For example, X1, X2, and X3 may each represent an example of a snapshot, such as the snapshots 135 or 235 described with reference to FIGS. 1 and 2. In this example, the snapshot X1 may be a full snapshot that may be obtained at a first time. The snapshots X2 and X3 may each be incremental snapshots that may be obtained at second and third times, respectively, that are after the first time. The full snapshot X1 may represent a state or version of a data block at a first time. For example, the full snapshot X1 may store data associated with (e.g., included in) each partition 320 of the data block at the first time (e.g., each of the partitions 320-a, 320-b, 320-c, and 320-d). The partitions 320 may represent ranges of data addresses or other subsets of data within the data block.

The incremental snapshots X2 and X3 may store data that represents changes to one or more partitions 320 of the data block. For example, the incremental snapshot X2 may store data that represents changes to the partition 320-b since the first time and that represents changes to the partition 320-d since the first time. At the second time at which the incremental snapshot X2 is obtained, one or more read or write operations may have changed at least a portion of the data B1 and D1 stored in the partitions 320-b and 320-d, and the changed data may be represented by B2 and D2. The snapshot X2 may store an empty data set (e.g., null data) for the other partitions 320-a and 320-c based on the data in these partitions 320 not having changed since the first time or the second time. The incremental snapshot X3 may similarly store data that represents changes to the partitions 320-a and 320-b since the first time. For example, at the third time at which the incremental snapshot X3 is obtained, one or more read or write operations may have changed at least a portion of the data A1 and B2 stored in the partitions 320-a and 320-b, and the changed data may be represented by A3 and B3. The snapshot X3 may store an empty data set (e.g., null data) for the other partitions 320-c and 320-d based on the data in these partitions 320 not having changed since the first time or the second time.

The snapshots in the snapshot chain at 300 may be forward incremental, as described with reference to FIG. 1. That is, the snapshot X3 may depend from the snapshot X2, which may depend from the snapshot X1. In other words, the snapshot X3 may not be recoverable without accessing the snapshots X2 and X1, which were obtained before the snapshot X3. If the DMS receives a request to restore the data block to a version associated with the third time at which X3 was obtained, the DMS may restore the requested version of the data block by accessing each of X1, X2, and X3 to obtain the most recent data in the snapshot chain. In some cases, if the snapshot chain is relatively long, such access operations may be relatively complex and time consuming. As such, the DMS described herein may perform a reverse operation to reverse an order of the snapshot chain and generate a new full snapshot.

At 305, the DMS may perform the reverse operation to reverse an order of the snapshot chain and generate a new full snapshot. For example, the DMS may perform write operations to write the most recent data for each partition 320 to the snapshot X3 based on the snapshot X3 being a most recent snapshot in the snapshot chain. The DMS may determine whether each partition 320 in the snapshot X3 is currently storing data or not. If a partition 320 is storing an empty data set, such as the partitions 320-c and 320-d in FIG. 3, the DMS may scan the snapshot chain to identify a most recent snapshot that does include data in the respective partition 320. For example, the snapshot X1 may include the most recent data for the partition 320-c, and the snapshot X2 may include the most recent data for the partition 320-d. The DMS may thereby write the data from the snapshots X1 and X2 to the snapshot X3.

After writing data for all of the partitions to the snapshot X3, the DMS may perform other write operations to move other data in the snapshot chain to a most recent snapshot. For example, the DMS may write the data A1 for the partition 320-a from the snapshot X1 to the snapshot X2 based on the snapshot X2 being a more recent snapshot and including an empty data set in the partition 320-a. To facilitate writing data between snapshots, the DMS may generate a patch file for each snapshot. The patch files may be stored in a distributed file system, as described with reference to FIG. 1. The DMS may generate the patch files for each snapshot in the snapshot chain regardless of whether the snapshots are marked for deletion or not to facilitate data exchanges between the snapshots as part of the reverse operation.

310 illustrates an example of the snapshot chain after the reverse operation is performed. The snapshots in the reversed snapshot chain may be reverse-incremental, as described with reference to FIG. 1. For example, the snapshot X1 may depend from the snapshot X2, which may depend from the snapshot X3. In other words, the snapshot X1 may not be recoverable without accessing the snapshots X2 and X3, which were obtained after the snapshot X1. The snapshot X3 may be directly recoverable, which may improve latency and reduce complexity associated with recovery operations, in some examples.

In this example, a client may transmit a request to the DMS to mark the snapshot X2 for deletion. That is, the snapshot X2 may be expired. Although the snapshot X2 is marked for deletion, in this example, the DMS may generate a patch file for the snapshot X2 and may perform one or more read and write operations for the snapshot X2 to move the data from the snapshot X2 to the snapshot X3 or to move other data, such as D1, to the snapshot X2. That is, the DMS may act as though the snapshot X2 is not deleted for the purposes of performing the reverse operation, which may result in relatively high overhead associated with performing the reverse operation.

At 315, after the reverse operation is complete (e.g., after the most recent data in the snapshot chain is moved as far right as possible), the DMS may perform a consolidation operation to consolidate the data in the expired snapshot X2 with the data in a previous snapshot X1. To perform the consolidation operation, the DMS may write data from a partition 320 of the expired snapshot X2 to the corresponding partition of the previous snapshot X1 if there is an empty data set in the corresponding partition of the previous snapshot X1. In the example of FIG. 3, after the reverse operation is performed, the snapshot X1 may include an empty data set in each of the partitions 320-a, 320-c, and 320-d. The expired snapshot may include data in the partitions 320-a and 320-d (e.g., A1 and D1). Thus, the DMS may write the data A1 and D1 from the expired snapshot X2 to the snapshot X1. The DMS may refrain from writing the data B2 in the partition 320-b of the expired snapshot X2 because the previous snapshot X1 may already include data in the partition 320-b. Even though the data B1 is associated with an older version of the partition 320-b than the data B2 in the expired snapshot X2, the DMS may maintain the data B1 because it has not been marked for deletion. Thus, the DMS may maintain, as part of the consolidation operation, any data that has not been marked for deletion, and may fill any remaining empty partitions 320 in the snapshot X1 with data from the expired snapshot X2.

The DMS may perform such a consolidation operation for any one or more snapshots that are marked for deletion. In some examples, if two or more consecutive snapshots in the snapshot chain are marked for deletion, the DMS may consolidate the data in the two or more expired snapshots with data in a single snapshot prior to the two or more consecutive expired snapshots in the snapshot chain. After the consolidation operation at 310, the expired snapshot X2 may include data in the partition 320-b and empty data sets in the remaining partitions.

At 315, after completing the consolidation operation, the DMS may perform a garbage collection operation. For example, the DMS may garbage collect any expired snapshots in the snapshot chain. In this example, the DMS may garbage collect (e.g., delete or remove) the expired snapshot X2 based on the client marking the snapshot X2 for deletion. That is, the DMS may delete the data B2 associated with the partition 320-b at the second point-in-time at which the snapshot X2 was obtained. After the garbage collection, the snapshot X1 may depend directly from the snapshot X3.

In some other examples, a different snapshot in the snapshot chain may be marked for deletion, such as the full snapshot X1. In this example, the DMS may perform the reverse operation similar to 300 and 305. The DMS may subsequently consolidate the data in the full snapshot with the data in the snapshot X2 from which the full snapshot depends in the reversed snapshot chain. The DMS may garbage collect the full snapshot after reversing the chain and consolidating the data. The DMS may perform similar reversal, consolidation, and garbage collection processes for any type of snapshot chain including any quantity of snapshots and any quantity of one or more expired snapshots.

In this example, the DMS may perform three separate operations to reverse an order of the snapshot chain, consolidate data within the snapshot chain, and delete any expired data. The DMS may perform such operations to improve recovery performance, and reduce storage consumption by removing any expired snapshots. However, performing three separate operations to reverse the snapshot chain and remove expired data may be associated with relatively high processing and resource consumption. Additionally, or alternatively, generating patch files for each snapshot (including the expired snapshot(s)) to perform the reverse operation may be associated with relatively high input/output and central processing unit (CPU) processing consumption.

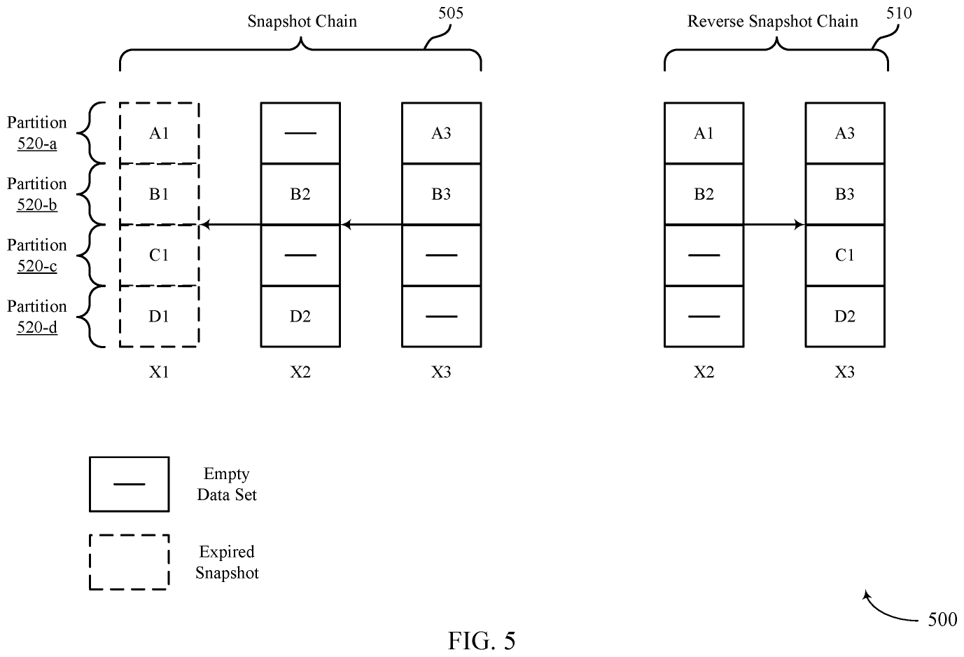

Techniques, systems, and devices described herein provide for the DMS to perform consolidation and garbage collection inline with the snapshot reversal operation. That is, the DMS may perform a single reverse operation that may generate a new full snapshot and garbage collect any expired data all in one operation. The DMS may refrain from calling and/or executing multiple different operations. As such, the DMS may delete the expired data upon reversal, instead of waiting for a next garbage collection operation to occur, which may improve latency. Additionally, or alternatively, the DMS may refrain from generating patch files for expired snapshots, which may reduce processing and storage consumption, among other examples. Techniques for performing such optimized reverse operations are described in further detail elsewhere herein, including with reference to FIGS. 4 and 5.

FIG. 4 shows an example of an inline reverse snapshot chain operation 400 that supports reverse operation for snapshot chains with inline consolidation and garbage collection in accordance with aspects of the present disclosure. The inline reverse snapshot chain operation may implement or be implemented by aspects of the computing environment 100 and the computing environment architecture 200, as described with reference to FIGS. 1 and 2. For example, the inline reverse snapshot chain operation 400 illustrates a reverse operation for a snapshot chain that includes snapshots X1, X2, and X3, which may represent examples of the snapshots 135 and 235 described with reference to FIGS. 1 and 2. In this example, the incremental snapshot X2 may be an expired snapshot, and the DMS may reverse the snapshot chain and garbage collect expired data as part of a same operation.

The snapshot chain 405 may represent an example of the snapshot chain described with reference to FIG. 3 (e.g., before the reverse operation). For example, the snapshot chain 405 may include the snapshots X1, X2, and X3, which may be obtained by the DMS at first, second, and third times, respectively. The snapshots may represent data stored within one or more partitions 420 of a data block at the respective times. The snapshot chain 405 may include the full snapshot X1, which may include data stored in each partition of the data block at the first time (e.g., each of the partitions 420-a, 420-b, 420-c, and 420-d). The snapshots X2 and X3 may each be incremental snapshots that may be obtained at second and third times, respectively, that are after the first time. The partitions 420 may represent ranges of data addresses or other subsets of data within the data block.

The incremental snapshots X2 and X3 may store data that represents changes to one or more partitions 420 of the data block. For example, the incremental snapshot X2 may store data that represents changes to the partition 420-b since the first time and that represents changes to the partition 420-d since the first time. The snapshot X2 may store an empty data set (e.g., null data) for the other partitions 420-a and 420-c based on the data in these partitions 420 not having changed since the first time. The incremental snapshot X3 may similarly store data that represents changes to the partitions 420-a and 420-b since the first time. The snapshot X3 may store an empty data set (e.g., null data) for the other partitions 420-c and 420)-d based on the data in these partitions 420 not having changed since the first time or the second time.

Although the snapshots are described as including data representative of a data block at different points in time, it is to be understood that the snapshots may back up data for any size or type of client data or other computing objects. For example, the snapshots may represent different versions of a VM or some other computing object. The partitions 420 may represent examples of subsets of information within the target object being backed up. For example, the partitions 420 may represent a range of bytes within a patch file block (e.g., 64 kilobytes), or some other unit of information.

The snapshots in the snapshot chain 405 may be forward incremental, as described with reference to FIGS. 1-3. That is, the snapshot X3 may depend from the snapshot X2, which may depend from the snapshot X1. In other words, the snapshot X3 may not be recoverable without accessing the snapshots X2 and X1, which were obtained before the snapshot X3. If the DMS receives a request to restore the data block to a version associated with the third time at which X3 was obtained, the DMS may restore the requested version of the data block by accessing each of X1, X2, and X3 to obtain the most recent data in the snapshot chain. In some cases (e.g., if the snapshot chain is relatively long), such access operations may be relatively complex and time consuming. As such, the DMS described herein may perform a reverse operation to reverse an order of the snapshot chain and convert the most recent (e.g., most recently obtained) incremental snapshot X3 in the snapshot chain 405 to a new full snapshot.

As described herein, the DMS may perform the inline reverse snapshot chain operation 400 to obtain the reversed snapshot chain 410 using a single operation. The inline reverse snapshot chain operation 400 may represent an example of the reverse operation described with reference to FIG. 3, but may support execution of the consolidation and garbage collection operations inline with the reverse operation. That is, the DMS may execute the reversal, consolidation, and garbage collection of the snapshot chain 405 using a single operation (e.g., a single function or set of code rather than separate set of instructions in memory).

The DMS may perform the described inline reverse snapshot chain operation 400 by identifying most recent data for each partition 420 in the snapshot chain 405. The most recent data may correspond to a most recent backup of the respective partition. For example, the data A3 and the data B3 in the snapshot X3 may be the most recent data for the partitions 420-a and 420-b, respectively, because they may be included in the most recently obtained snapshot X3 in the snapshot chain 405. The data C1 in the snapshot X1 may be the most recent data for the partition 420-c because the more recent snapshots X2 and X3 may not include data for the partition 420-c. The data D2 in the snapshot X2 may be the most recent data for the partition 420-d.

The DMS may perform one or more write operations to conditionally write the most recent data to a next snapshot in the snapshot chain 405. That is, if there is a snapshot that was obtained more recently than the snapshot that includes the most recent data for a given partition 420 (e.g., and, by definition, includes an empty data set at the partition 420), the DMS may write the most recent data to the most recent snapshot if the most recent snapshot satisfies one or more conditions defined herein. The conditions may be that the snapshot is a most recent snapshot in the snapshot chain 405 that is not expired (e.g., not marked for deletion) and that the snapshot includes an empty data set for the respective partition. By performing such conditional writing, the DMS may move all of the most recent data forward in the snapshot chain 405 (e.g., reversing an order of the snapshot chain 405) and may refrain from writing to any expired snapshot. In some examples, such conditional writing may be executed in accordance with a loop in code (e.g., reverse code). For example, the code may scan the snapshot chain 405 in order from a most recently obtained snapshot to an earliest snapshot to identify a snapshot that satisfies the conditions, and the code may instruct the DMS to write to the identified snapshot. In some examples, the code may include a first construct (e.g., a scanner construct) to read a patch file in the original snapshot chain 405, and a second construct (e.g., a builder construct) to write to a patch file in the reversed snapshot chain 410.

In the example of FIG. 4, the DMS may receive a request from a client to mark the incremental snapshot X2 for deletion. The snapshot X2 may thereby be expired. The DMS may refrain from writing to the snapshot X2 during the inline reverse snapshot chain operation 400 based on the snapshot X2 being expired and the conditional writing performed by the DMS. By skipping writing to any expired snapshots, the DMS may refrain from generating a patch file for the expired snapshots, which may reduce processing and storage consumption. For example, if the client requests to delete a snapshot, patch file information for the snapshot may be empty, and the DMS may refrain from creating a patch file for that snapshot. A construct for writing data to patch files (e.g., the builder construct) may be created to write data to new patch files for all other snapshots that are not marked for deletion.

The conditional writing to reverse the order of the snapshot chain 405 may, in this example, include the DMS writing the data C1 from the snapshot X1 to the snapshot X3 based on the snapshot X3 being the most recently obtained snapshot in the snapshot chain 405 that includes an empty data set in the partition 420-c and that is not marked for deletion. The DMS may refrain from (e.g., skip) writing the data C1 to the snapshot X2 because the snapshot X2 may be marked for deletion. The writing may further include the DMS writing the data D2 from the snapshot X2 to the snapshot X3 based on the snapshot X2 including the most recent version of the partition 420-d and X3 being the most recently obtained snapshot in the snapshot chain 405 that includes an empty data set in the partition 420-d and that is not marked for expiration. That is, in some examples, data may be moved from a snapshot that is expired (e.g., marked for deletion) to another non-expired snapshot that is more recently obtained than the expired snapshot. Such writing from the expired snapshot may occur if the expired snapshot includes a most recent version of a given partition 420.

In this example, the DMS may skip writing A1 to the snapshot X2 because the snapshot X2 may be marked for deletion. Thus, because the other snapshots in the snapshot chain 405 that were obtained more recently than the snapshot X1 and are not marked for deletion already include data in the partition 420-a (e.g., the data A3), the DMS may maintain the data A1 in the snapshot X1.

After performing all of the conditional writing to reverse the order of the snapshot chain, the DMS may consolidate the data as part of the reverse operation. The consolidation operation may represent a task or function that is called inline by the reverse operation, such that the consolidation is performed before the reverse operation is complete. For example, the DMS may consolidate the data in the expired snapshot X2 with the data in the preceding snapshot X1. In this example, because the snapshot X1 already includes data in the partitions 420-b and 420-d, the DMS may not write any of the expired data to the snapshot X1. However, if, for example, the expired snapshot X2 included data (e.g., C2) in the partition 420-c, and the snapshot X1 included an empty data set after writing C1 to the snapshot X3, the DMS may consolidate the data C2 from the snapshot X2 to the snapshot X1.

After reversing the order and consolidating the data, the DMS may perform inline garbage collection as part of the reverse operation. The garbage collection operation may represent a task or function that is called inline by the reverse operation, such that the garbage collection is performed before the reverse operation is complete. For example, the DMS may delete any expired snapshots, such as the snapshot X2. The DMS may delete all data that is stored in the snapshots that are marked for deletion. In some examples, some expired data may be moved to a most recent snapshot (e.g., D2 in this example) or consolidated with a prior snapshot, and the DMS may delete all remaining data that is stored in the expired snapshot after the writing and consolidating. Additionally, or alternatively, if no data was moved from the expired snapshot during the writing portions of the reverse operation, the DMS may delete, as part of the deleting the expired snapshot, all of the data that was included in the snapshot at the time the user marked the snapshot for deletion. The consolidation and garbage collection performed inline as part of the reverse operation may provide for relatively quick space reclamation. For example, without inline operations, the space may be reclaimed after a next consolidation job and garbage collection job are performed, which may occur a relatively long time period after the reverse operation. The total amount of storage space that is reclaimed may be equal to a difference between a size of the snapshot chain 405 (e.g., a forward chain) and a size of the reversed snapshot chain 410. In this example, the space reclamation may be equal to a single snapshot (e.g., X2).

After performing the reverse operation with inline consolidation and garbage collection, the DMS may store the reversed snapshot chain 410. The reversed snapshot chain 410 may include reverse incremental snapshots, as described with reference to FIGS. 1-3. That is, the snapshot X1 may depend from the snapshot X3. The DMS may thereby recover the data block to the third point in time version associated with the third time at which the snapshot X3 was obtained by accessing the snapshot X3 directly, which may improve efficiency and reduce processing as compared with accessing the snapshots X3, X2, and X1 to recover to the third time, as would be done using the snapshot chain 405 before the reverse operation. To recover the snapshot X1, the DMS may access the snapshots X3 and X1. If a snapshot chain is relatively long, the reverse operation may provide for more recent versions of a data block to be recovered faster than if the snapshot chain were not reversed.

The DMS as described herein may thereby perform a single operation to reverse the snapshot chain 405, consolidate the snapshots, and garbage collect any expired snapshots. The DMS may perform conditional writes during the reverse operation to refrain from (e.g., skip) writing to any expired snapshots, such that the DMS may reduce I/O and reduce patch file generation by generating patch files for any snapshot that is not expired and refraining from generating patch files for expired snapshots. The DMS may perform the operation as a single job or task, and the consolidation and garbage collection may be performed inline. Without inline consolidation and garbage collection, the DMS may wait for a subsequent garbage collection operation or consolidation operation to be scheduled or requested, before generating the reversed snapshot chain 410, which may increase latency and processing. The described techniques may thereby provide for more efficient reverse operations, among other examples.

FIG. 5 shows an example of a inline snapshot chain reverse operation 500 that supports reverse operation for snapshot chains with inline consolidation and garbage collection in accordance with aspects of the present disclosure. The inline reverse snapshot operation may implement or be implemented by aspects of the computing environment 100 and the computing environment architecture 200, as described with reference to FIGS. 1 and 2. For example, the inline snapshot chain reverse operation 500 illustrates a reverse operation for a snapshot chain that includes snapshots X1, X2, and X3, which may represent examples of the snapshots 135 and 235 described with reference to FIGS. 1 and 2. In this example, the full snapshot X1 may be an expired snapshot, and the DMS may reverse the snapshot chain and garbage collect expired data as part of a same operation.

The snapshot chain 505 may represent an example of the snapshot chain described with reference to FIGS. 3 and 4 (e.g., before the reverse operation). For example, the snapshot chain 505 may include the snapshots X1, X2, and X3, which may be obtained by the DMS at first, second, and third times, respectively. The snapshots may represent data stored within one or more partitions 520 of a data block at the respective times. The snapshot chain may include the full snapshot X1, which may include data stored in each partition of the data block at the first time (e.g., each of the partitions 520-a, 520-b, 520-c, and 520-d). The snapshots X2 and X3 may each be incremental snapshots that may be obtained at second and third times, respectively, that are after the first time. The partitions 520 may represent ranges of data addresses or other subsets of data within the data block.

The incremental snapshots X2 and X3 may store data that represents changes to one or more partitions 520 of the data block. For example, the incremental snapshot X2 may store data that represents changes to the partition 520-b since the first time and that represents changes to the partition 520-d since the first time. The snapshot X2 may store an empty data set (e.g., null data) for the other partitions 520-a and 520-c based on the data in these partitions 520 not having changed since the first time. The incremental snapshot X3 may similarly store data that represents changes to the partitions 520-a and 520-b since the first time. The snapshot X3 may store an empty data set (e.g., null data) for the other partitions 520-c and 520-d based on the data in these partitions 520 not having changed since the first time or the second time.

The snapshots in the snapshot chain 505 may be forward incremental, as described with reference to FIGS. 1-3. That is, the snapshot X3 may depend from the snapshot X2, which may depend from the snapshot X1. In other words, the snapshot X3 may not be recoverable without accessing the snapshots X2 and X1, which were obtained before the snapshot X3. If the DMS receives a request to restore the data block to a version associated with the third time at which X3 was obtained, the DMS may restore the requested version of the data block by accessing each of X1, X2, and X3 to obtain the most recent data in the snapshot chain. In some cases, if the snapshot chain is relatively long, such access operations may be relatively complex and time consuming. As such, the DMS described herein may perform a reverse operation to reverse an order of the snapshot chain and convert a most recent incremental snapshot X3 to a new full snapshot.

Although the snapshots are described as including data representative of a data block at different points in time, it is to be understood that the snapshots may back up data for any size or type of client data or other computing objects. For example, the snapshots may represent different versions of a VM or some other computing object. The partitions 520 may represent examples of subsets of information within the target object being backed up. For example, the partitions 520 may represent a range of bytes within a patch file block (e.g., 64 kilobytes), or some other unit of information.

As described herein, the DMS may perform the inline reverse snapshot operation 500 to obtain the reversed snapshot chain 510 using a single operation. The inline reverse snapshot operation 500 may represent an example of the reverse operation described with reference to FIG. 4. For example, the DMS may perform inline consolidation and garbage collection as part of the inline reverse snapshot operation 500. That is, the DMS may execute the reversal, consolidation, and garbage collection of the snapshot chain 505 using a single operation (e.g., a single function or set of code rather than separate set of instructions in memory).

As described with reference to FIG. 4, the DMS may perform the described inline reverse snapshot operation 500 by identifying most recent data for each partition 520 in the snapshot chain 505. The most recent data may correspond to a most recent backup of the respective partition. For example, the data A3 and the data B3 in the snapshot X3 may be the most recent data for the partitions 520-a and 520-b, respectively, because they may be included in the most recently obtained snapshot X3 in the snapshot chain 505. The data C1 in the snapshot X1 may be the most recent data for the partition 520-c because the more recent snapshots X2 and X3 may not include data for the partition 520-c. The data D2 in the snapshot X2 may be the most recent data for the partition 520-d.

The DMS may perform one or more write operations to conditionally write the most recent data to a next snapshot in the snapshot chain 505. That is, if there is a snapshot that was obtained more recently than the snapshot that includes the most recent data for a given partition 520 (e.g., and, by definition, includes an empty data set at the partition 520), the DMS may write the most recent data to the most recent snapshot if the most recent snapshot satisfies one or more conditions defined herein. The conditions may be that the snapshot is a most recent snapshot in the snapshot chain 505 that is not expired (e.g., not marked for deletion) and that the snapshot includes an empty data set for the respective partition. By performing such conditional writing, the DMS may refrain from writing to an expired snapshot.

In the example of FIG. 5, the DMS may receive a request from a client to mark the full snapshot X1 for deletion. The snapshot X1 may thereby be referred to as an expired snapshot. The DMS may refrain from writing to the snapshot X1 during the inline reverse operation 500 based on the snapshot X1 being expired. By skipping writing to any expired snapshots, the DMS may refrain from generating a patch file for the expired snapshots, which may reduce processing and storage consumption.

The conditional writing to reverse the order of the snapshot chain 505 may, in this example, include the DMS writing most recent data to the empty partitions 520-c and 520-d in the most recently obtained snapshot X3 in the snapshot chain 505. The most recent version of the partition 520-c may be stored as the data C1 in the snapshot X1. The DMS may write the data C1 to the snapshot X3 based on the snapshot X3 not being marked for expiration and including the empty data set in the partition 520-c. The most recent version of the partition 520-d may be stored as the data D2 in the snapshot X2. The DMS may write the data D2 to the snapshot X3 not being marked for expiration and including the empty data set in the partition 520-d.

The DMS may continue to write other data from the snapshot X1 to any empty partitions 520 (e.g., partitions 520 that include an empty data set) in the snapshot X2. Such writing may be part of the conditional writing, or may be part of the consolidation operation, or both. For example, as part of the conditional writing for the reverse operation, the DMS may move the most recent data as far forward in the snapshot chain 505 as possible while complying with the described write conditions (e.g., skipping writing to any expired snapshots). The most recently obtained snapshot X3 may represent a front of the snapshot chain 505 and an earliest obtained snapshot X1 may represent the back of the snapshot chain 505. In some examples, as part of moving the data as far forward as possible, the DMS may consolidate the data in the expired snapshot X1 with the data in a subsequent consecutive snapshot in the snapshot chain 505 (e.g., X2). For example, the DMS may write the data A1 to the snapshot X2 based on the snapshot X2 including an empty data set in the partition 520-a. However, the DMS may refrain from writing the data B1 to the snapshot X2 based on the snapshot X2 already including the data B2, and the DMS may refrain from writing the data D1 to the snapshot X2 based on the snapshot X2 already including the data D2.

After performing the conditional writes and consolidation, the DMS may perform inline garbage collection as part of the reverse operation. The garbage collection operation may represent a task or function that is called inline by the reverse operation, such that the garbage collection is performed before the reverse operation is complete. For example, the DMS may delete any expired snapshots, such as the snapshot X1. The DMS may delete all data that is stored in the snapshots that are marked for deletion. In some examples, some expired data may be moved to (e.g., written to, consolidated with) a more recent snapshot (e.g., C1, D2, and A1 in this example), and the DMS may delete all remaining data that is stored in the expired snapshot. Additionally, or alternatively, if no data was moved from the expired snapshot during the writing portions of the reverse operation, the DMS may delete, as part of the deleting the expired snapshot, all of the data that was included in the snapshot at the time the user marked the snapshot for deletion. In this example, the DMS may delete the data B1.

After performing the reverse operation with inline consolidation and garbage collection, the DMS may store the reversed snapshot chain 510. The reversed snapshot chain 510 may include reverse incremental snapshots, as described with reference to FIGS. 1-4. That is, the snapshot X2 may depend from the snapshot X3. The DMS may thereby recover the data block to the third point in time version associated with the third time at which the snapshot X3 was obtained by accessing the snapshot X3 directly, which may improve efficiency and reduce processing as compared with accessing the snapshots X3, X2, and X1 to recover to the third time, as would be done using the snapshot chain 505 before the reverse operation. To recover the snapshot X2, the DMS may access the snapshot X3. If a snapshot chain is relatively long, the reverse operation may provide for more recent versions of a data block to be recovered faster than if the snapshot chain were not reversed.

The DMS as described herein may thereby perform a single operation to reverse the snapshot chain 505, consolidate the snapshots, and garbage collect any expired snapshots. The DMS may perform conditional writes during the reverse operation to refrain from (e.g., skip) writing to any expired snapshots, such that the DMS may reduce I/O and reduce patch file generation by generating patch files for any snapshot that is not expired and refraining from generating patch files for expired snapshots. The DMS may perform the operation as a single job or task, and the consolidation and garbage collection may be performed inline. Without inline consolidation and garbage collect, the DMS may wait for a subsequent garbage collection operation or consolidation operation to be scheduled or requested, before generating the reversed snapshot chain 510, which may increase latency and processing. The described techniques may thereby provide for more efficient reverse operations, among other examples.

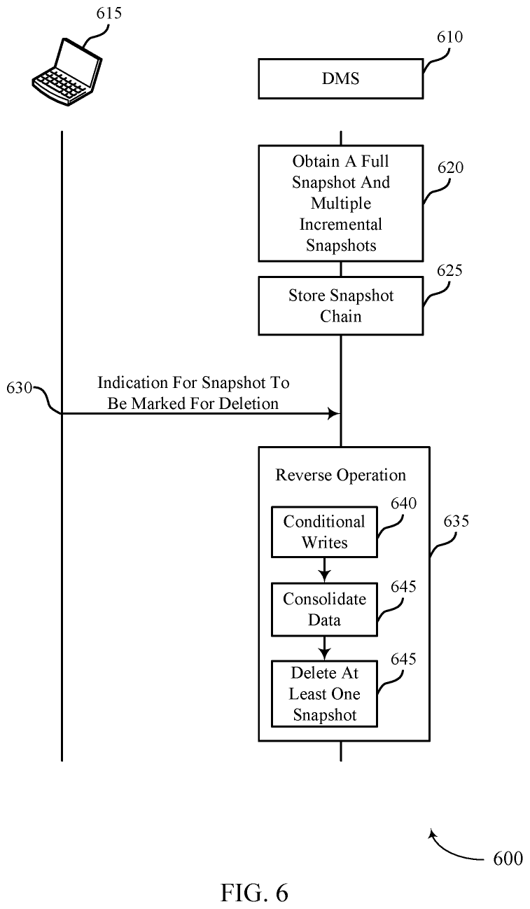

FIG. 6 shows an example of a process flow 600 that supports reverse operation for snapshot chains with inline consolidation and garbage collection in accordance with aspects of the present disclosure. The process flow 600 may implement or be implemented by aspects of FIGS. 1-5. For example, the process flow 600 may be implemented by DMS 610 and a computing device 615, which may represent examples of a corresponding DMS and computing device as described with reference to FIGS. 1-5. In this example, the DMS 610 may perform a reverse operation that includes inline consolidation and garbage collection operations to reduce storage space and improve efficiency associated with recovery of data for the computing device 615.

In some aspects, the operations illustrated in the process flow 600 may be performed by hardware (e.g., including circuitry, processing blocks, logic components, and other components), code (e.g., software or firmware) executed by a processor, or any combination thereof. For example, aspects of the process flow 600 may be implemented or managed by a DMS, a reverse operation manager, or some other software or application that is associated with data backup and recovery.

At 620, the DMS 610 may obtain a full snapshot of a data block and one or more incremental snapshots of the data block. The incremental snapshots may each include data associated with changes to partitions (e.g., portions) of the data block since the full snapshot. Although illustrated as a single step in FIG. 6, it is to be understood that the DMS 610 may obtain the full snapshot at a first time, and may obtain each incremental snapshot at a respective second time that is after the first time. The full snapshot and incremental snapshots may represent examples of corresponding snapshots as described with reference to FIGS. 1-5.

At 625, in some examples, the DMS 610 may store the full snapshot and the incremental snapshots as a snapshot chain. The DMS 610 may store the snapshot chain in a cloud environment, database, or other storage location associated with the DMS 610. In some examples, the snapshot chain may be stored as a series of patch files in a distributed file system, or in some other format, as described with reference to FIG. 2. The incremental snapshots may each depend from the full snapshot in the snapshot chain. In some examples, the DMS 610 may store the full snapshot first after obtaining the full snapshot and may subsequently store each incremental snapshot as the incremental snapshots are obtained.

At 630, the DMS may receive, from the computing device 615 (e.g., from a user or client via a user interface), a request to mark at least one snapshot in the snapshot chain for deletion. The user may request to delete the full snapshot, an incremental snapshot, or any combination thereof. The user may request to delete the snapshots periodically or based on one or more scenarios or parameters associated with the user data. The DMS 610 may mark the indicated snapshot(s) for deletion. As such, the snapshot(s) may be referred to as expired snapshots, and may be deleted in a subsequent reverse operation or garbage collection operation performed by the DMS 610.

At 635, the DMS 610 may perform a reverse operation, which may be an operation to reverse an order of the snapshot chain and to convert a most recent incremental snapshot (e.g., an incremental snapshot that was obtained more recently than other snapshots in the snapshot chain) to a new full snapshot. The DMS 610 may perform the reverse operation based on one or more conditions or thresholds being satisfied, as described with reference to FIG. 2. For example, the DMS 610 may perform the reverse operation based on a change rate associated with the snapshot chain exceeding a threshold, based on a length of the snapshot chain exceeding the threshold, based on one or more triggers, or any combination thereof.

At 640, as described herein, the DMS 610 may perform conditional writes as part of the reverse operation. For example, as part of the reverse operation, the DMS 610 may write, for a first partition of the data block, data associated with the first partition from a first snapshot in the snapshot chain that includes a most recent version of the data to a second snapshot that satisfies a set of conditions. The set of conditions may include the second snapshot being a most recent snapshot in the snapshot chain that has an empty data set in the respective partition being written and the second snapshot not being marked for deletion. The DMS 610 may perform such conditional writes to move the most recent data in the snapshot chain to the most recently obtained incremental snapshot that is not expired. The most recent incremental snapshot that is not expired may thereby become a new full snapshot for the snapshot chain.

The DMS 610 may continue the conditional writes to move other incremental data forward in the snapshot chain (e.g., toward more recently obtained snapshots) until all of the most recently obtained snapshots that are not marked for deletion include the most recent data. As part of the conditional writes, the DMS 610 may skip (e.g., refrain from) writing to any expired snapshot that was marked for deletion by the computing device 615. The DMS 610 may thereby generate patch files for the other snapshots and refrain from generating patch files for the expired snapshots. The conditional writes may reverse the order of the snapshot chain, such that the incremental snapshots may depend from the new full snapshot, which may be obtained more recently.

At 645, in some examples, as part of the reverse operation, and after performing the conditional writes, the DMS 610 may perform a consolidate the data in the snapshot chain. For example, the DMS 610 may consolidate data in any of the one or more snapshots that are marked for deletion with data in respective snapshots that are consecutive to and precede the one or more expired snapshots in the snapshot chain. Consolidating the data may include filling any empty partitions in the preceding snapshots with data from the expired snapshots and maintaining remaining data in the expired snapshots, as described with reference to FIGS. 4 and 5. If there are more than one consecutive snapshots that are marked for deletion, the consecutive expired snapshots may be consolidated together and with a preceding non-expired snapshot.

At 650, as part of the reverse operation, after writing the data and consolidating the data, the DMS 610 may delete the at least one snapshot that is marked for deletion. That is, the DMS 610 may garbage collect any snapshot that the user marked for deletion. As part of the deleting, the DMS 610 may delete any data that remains in the expired snapshot(s) after the conditional writing and consolidating.

The DMS 610 may perform the consolidating and garbage collection inline as part of the reverse operation, such that the resulting reversed snapshot chain may be consolidating and expired data may be deleted. The reverse operation may be complete after the garbage collecting is complete. By performing the consolidation and garbage collection inline, the DMS 610 may reclaim storage space, reduce processing, and improve latency as compared with systems in which the DMS 610 may wait for subsequent consolidation and/or garbage collection operations to be scheduled and performed after the reverse operation.

The DMS 610 described herein may thereby support relatively efficient and reliable reverse operations to reverse an order of a snapshot chain, generate a new full snapshot, improve latency and reliability of recovery operations, and improve storage capacity, among other possibilities.

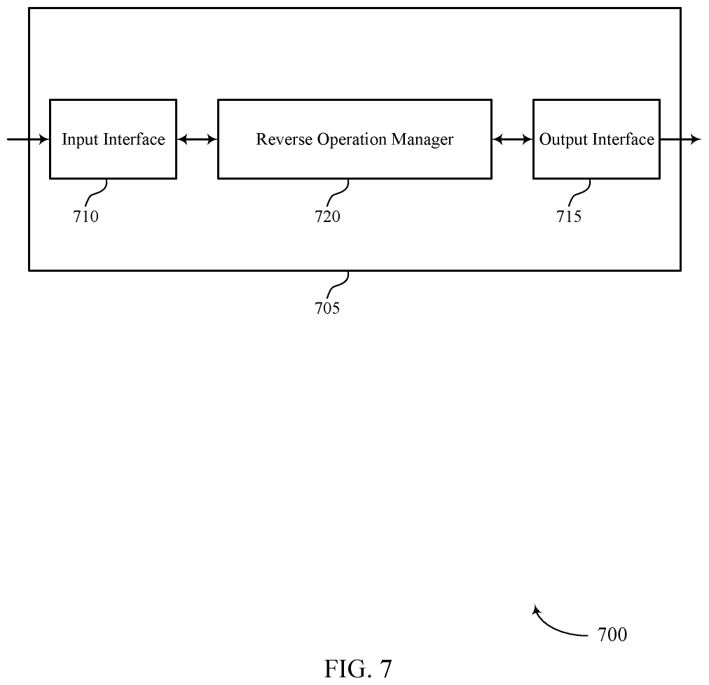

FIG. 7 shows a block diagram 700 of a system 705 that supports reverse operation for snapshot chains with inline consolidation and garbage collection in accordance with aspects of the present disclosure. The system 705 may be an example of aspects of a DMS as described herein. The system 705 may include an input interface 710, an output interface 715, and a reverse operation manager 720. The system 705, or one or more components of the system 705 (e.g., the input interface 710, the output interface 715, and the reverse operation manager 720), may include at least one processor, which may be coupled with at least one memory, to, individually or collectively, support or enable the described techniques. Each of these components may be in communication with one another (e.g., via one or more buses).

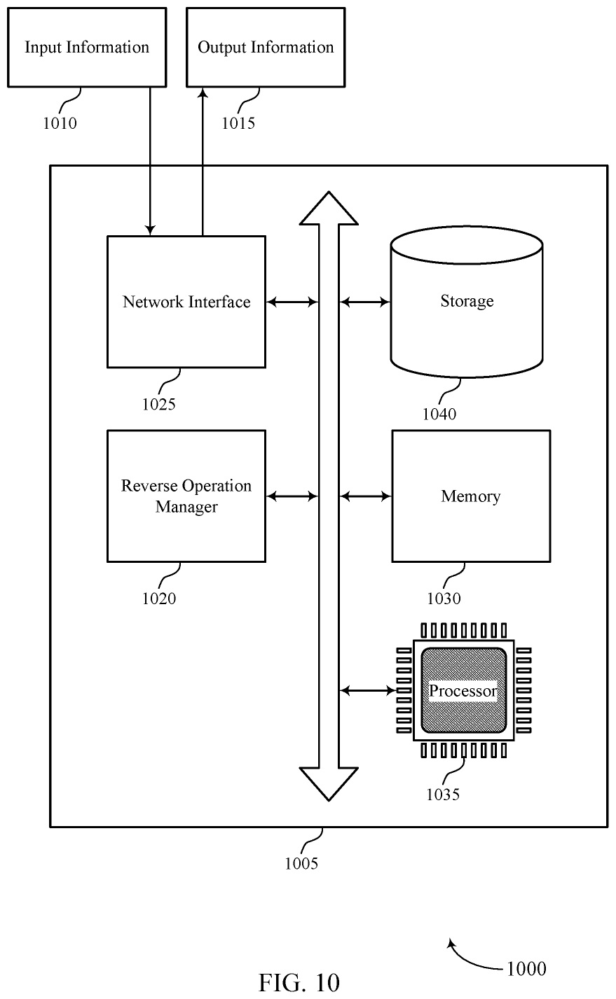

The input interface 710 may manage input signaling for the system 705. For example, the input interface 710) may receive input signaling (e.g., messages, packets, data, instructions, commands, or any other form of encoded information) from other systems or devices. The input interface 710 may send signaling corresponding to (e.g., representative of or otherwise based on) such input signaling to other components of the system 705 for processing. For example, the input interface 710 may transmit such corresponding signaling to the reverse operation manager 720 to support reverse operation for snapshot chains with inline consolidation and garbage collection. In some cases, the input interface 710 may be a component of a network interface 1025 as described with reference to FIG. 10.

The output interface 715 may manage output signaling for the system 705. For example, the output interface 715 may receive signaling from other components of the system 705, such as the reverse operation manager 720, and may transmit such output signaling corresponding to (e.g., representative of or otherwise based on) such signaling to other systems or devices. In some cases, the output interface 715 may be a component of a network interface 1025 as described with reference to FIG. 10.

The reverse operation manager 720, the input interface 710, the output interface 715, or various combinations thereof or various components thereof may be examples of means for performing various aspects of reverse operation for snapshot chains with inline consolidation and garbage collection as described herein. For example, the reverse operation manager 720, the input interface 710, the output interface 715, or various combinations or components thereof may be capable of performing one or more of the functions described herein.

In some examples, the reverse operation manager 720, the input interface 710, the output interface 715, or various combinations or components thereof may be implemented in hardware (e.g., in communications management circuitry). The hardware may include at least one of a processor, a DSP, an ASIC, an FPGA or other programmable logic device, a discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the reverse operation manager 720, the input interface 710, the output interface 715, or various combinations or components thereof may be implemented in code (e.g., as communications management software or firmware) executed by at least one processor. If implemented in code executed by at least one processor, the functions of the reverse operation manager 720, the input interface 710, the output interface 715, or various combinations or components thereof may be performed by a general-purpose processor, a DSP, a CPU, an ASIC, an FPGA, or any combination of these or other programmable logic devices (e.g., configured as or otherwise supporting, individually or collectively, a means for performing the functions described in the present disclosure).

In some examples, the reverse operation manager 720 may be configured to perform various operations (e.g., receiving, monitoring, transmitting) using or otherwise in cooperation with the input interface 710, the output interface 715, or both. For example, the reverse operation manager 720 may receive information from the input interface 710, send information to the output interface 715, or be integrated in combination with the input interface 710, the output interface 715, or both to receive information, transmit information, or perform various other operations as described herein.

For example, the reverse operation manager 720 may be configured as or otherwise support a means for obtaining a full snapshot of a data block and a set of multiple incremental snapshots that include data associated with changes to partitions of the data block since the full snapshot, where the full snapshot and the set of multiple incremental snapshots are stored as a snapshot chain. The reverse operation manager 720 may be configured as or otherwise support a means for receiving an indication that at least one snapshot of the snapshot chain is marked for deletion by a user. The reverse operation manager 720 may be configured as or otherwise support a means for performing an operation to reverse an order of the snapshot chain to convert a most recent incremental snapshot in the snapshot chain to a new full snapshot. In some examples, to perform the operation, the reverse operation manager 720 may be configured as or otherwise support a means for writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and deleting, as part the operation and after writing the data, the at least one snapshot based on the indication that the at least one snapshot is marked for deletion.

By including or configuring the reverse operation manager 720 in accordance with examples as described herein, the system 705 (e.g., at least one processor controlling or otherwise coupled with the input interface 710, the output interface 715, the reverse operation manager 720), or a combination thereof) may support techniques for reduced processing, reduced power consumption, and more efficient recovery, among other examples.

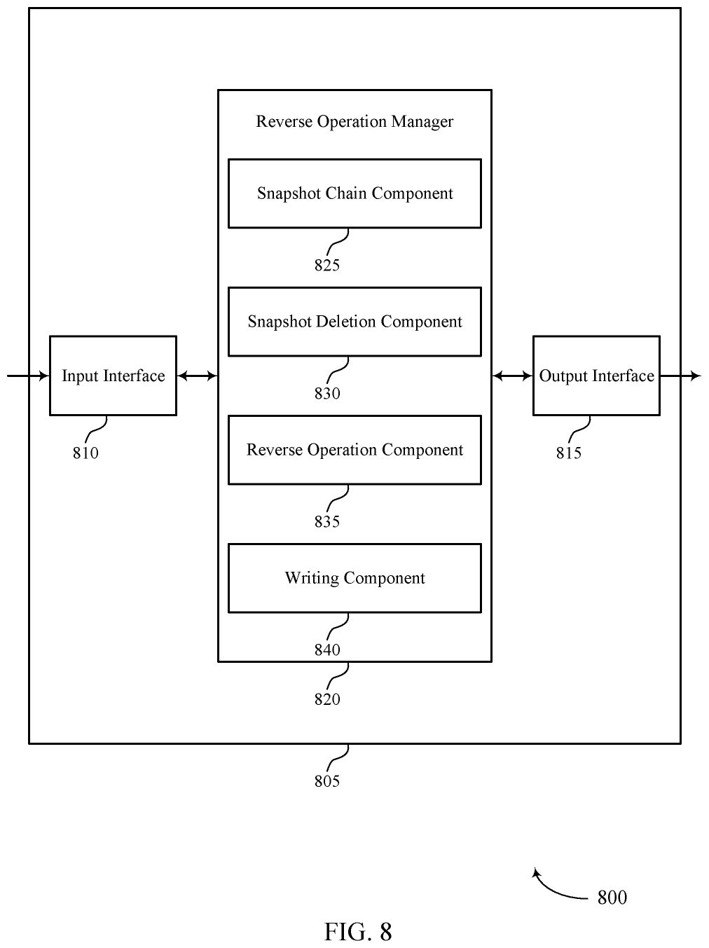

FIG. 8 shows a block diagram 800 of a system 805 that supports reverse operation for snapshot chains with inline consolidation and garbage collection in accordance with aspects of the present disclosure. In some examples, the system 805 may be an example of aspects of one or more components described with reference to FIG. 1, such as a DMS 110. The system 805 may be an example of aspects of a system 705 or a DMS 110 as described herein. The system 805 may include an input interface 810, an output interface 815, and a reverse operation manager 820. The system 805 may also include one or more processors. Each of these components may be in communication with one another (e.g., via one or more buses, communications links, communications interfaces, or any combination thereof).

The input interface 810 may manage input signaling for the system 805. For example, the input interface 810 may receive input signaling (e.g., messages, packets, data, instructions, commands, or any other form of encoded information) from other systems or devices. The input interface 810 may send signaling corresponding to (e.g., representative of or otherwise based on) such input signaling to other components of the system 805 for processing. For example, the input interface 810 may transmit such corresponding signaling to the reverse operation manager 820 to support reverse operation for snapshot chains with inline consolidation and garbage collection. In some cases, the input interface 810 may be a component of a network interface 1025 as described with reference to FIG. 10.

The output interface 815 may manage output signaling for the system 805. For example, the output interface 815 may receive signaling from other components of the system 805, such as the reverse operation manager 820, and may transmit such output signaling corresponding to (e.g., representative of or otherwise based on) such signaling to other systems or devices. In some cases, the output interface 815 may be a component of a network interface 1025 as described with reference to FIG. 10.

The system 805, or various components thereof, may be an example of means for performing various aspects of reverse operation for snapshot chains with inline consolidation and garbage collection as described herein. For example, the reverse operation manager 820 may include a snapshot chain component 825, a snapshot deletion component 830, a reverse operation component 835, or any combination thereof. The reverse operation manager 820) may be an example of aspects of a reverse operation manager 720 as described herein. In some examples, the reverse operation manager 820, or various components thereof, may be configured to perform various operations (e.g., receiving, monitoring, transmitting) using or otherwise in cooperation with the input interface 810, the output interface 815, or both. For example, the reverse operation manager 820 may receive information from the input interface 810, send information to the output interface 815, or be integrated in combination with the input interface 810, the output interface 815, or both to receive information, transmit information, or perform various other operations as described herein.

The snapshot chain component 825 may be configured as or otherwise support a means for obtaining a full snapshot of a data block and a set of multiple incremental snapshots that include data associated with changes to partitions of the data block since the full snapshot, where the full snapshot and the set of multiple incremental snapshots are stored as a snapshot chain. The snapshot deletion component 830 may be configured as or otherwise support a means for receiving an indication that at least one snapshot of the snapshot chain is marked for deletion by a user. The reverse operation component 835 may be configured as or otherwise support a means for performing an operation to reverse an order of the snapshot chain to convert a most recent incremental snapshot in the snapshot chain to a new full snapshot. In some examples, to perform the operation, the writing component 840 may be configured as or otherwise support a means for writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and the snapshot deletion component 830 may be configured as or otherwise support a means for deleting, as part the operation and after writing the data, the at least one snapshot based on the indication that the at least one snapshot is marked for deletion.

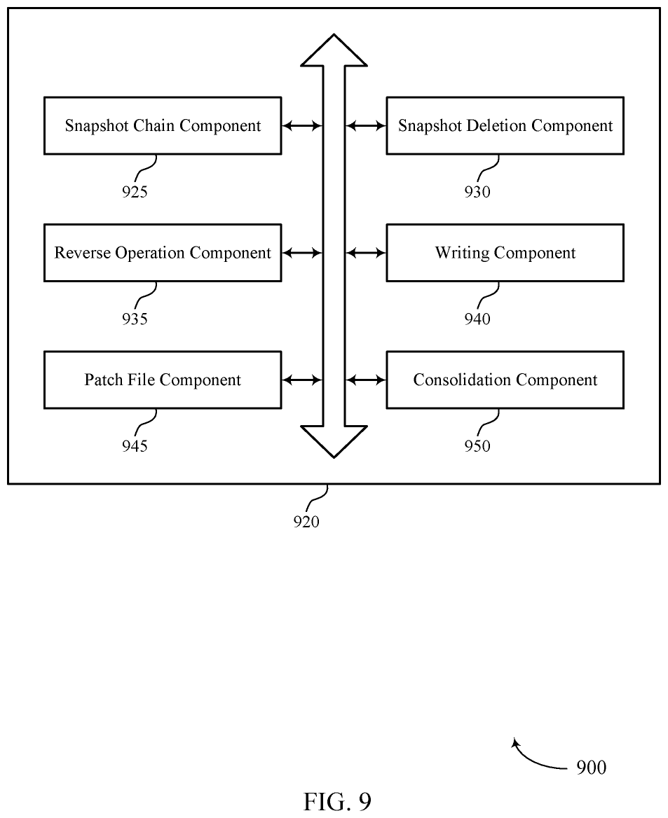

FIG. 9 shows a block diagram 900 of a reverse operation manager 920 that supports reverse operation for snapshot chains with inline consolidation and garbage collection in accordance with aspects of the present disclosure. The reverse operation manager 920 may be an example of aspects of a reverse operation manager 720, a reverse operation manager 820, or both, as described herein. The reverse operation manager 920, or various components thereof, may be an example of means for performing various aspects of reverse operation for snapshot chains with inline consolidation and garbage collection as described herein. For example, the reverse operation manager 920 may include a snapshot chain component 925, a snapshot deletion component 930, a reverse operation component 935, a writing component 940, a patch file component 945, a consolidation component 950, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The snapshot chain component 925 may be configured as or otherwise support a means for obtaining a full snapshot of a data block and a set of multiple incremental snapshots that include data associated with changes to partitions of the data block since the full snapshot, where the full snapshot and the set of multiple incremental snapshots are stored as a snapshot chain. The snapshot deletion component 930 may be configured as or otherwise support a means for receiving an indication that at least one snapshot of the snapshot chain is marked for deletion by a user. The reverse operation component 935 may be configured as or otherwise support a means for performing an operation to reverse an order of the snapshot chain to convert a most recent incremental snapshot in the snapshot chain to a new full snapshot. In some examples, to perform the operation, the writing component 940 may be configured as or otherwise support a means for writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and the snapshot deletion component 930 may be configured as or otherwise support a means for deleting, as part the operation and after writing the data, the at least one snapshot based on the indication that the at least one snapshot is marked for deletion.

In some examples, to support performing the operation, the writing component 940 may be configured as or otherwise support a means for skipping writing the data associated with the first partition to the at least one snapshot based on the at least one snapshot being marked for deletion.

In some examples, to support performing the operation, the writing component 940 may be configured as or otherwise support a means for writing the data, or second data, or both from the at least one snapshot to the second snapshot or to one or more other snapshots in the snapshot chain, the second data being a most recent version of the second data in one or more respective partitions, where, after writing the data, the second data, or both, the at least one snapshot includes expired data in one or more second partitions based on other data that is more recent than the expired data being present within the one or more second partitions in other snapshots in the snapshot chain.

In some examples, the snapshot deletion component 930 may be configured as or otherwise support a means for deleting the at least one snapshot includes deleting the expired data.

In some examples, to support performing the operation, the consolidation component 950) may be configured as or otherwise support a means for consolidating the expired data in the at least one snapshot with third data in a third snapshot that is obtained prior to the at least one snapshot in time. In some examples, to consolidate the expired data, the consolidation component 950) may be configured as or otherwise support a means for writing, for a second partition of the partitions of the data block, the expired data that is in the second partition from the at least one snapshot to the third snapshot based on the third data in the third snapshot including an empty data set in the second partition and the consolidation component 950 may be configured as or otherwise support a means for skipping writing, for the second partition of the partitions of the data block, the expired data that is in the second partition from the at least one snapshot to the third snapshot based on the third snapshot including the third data in the second partition.

In some examples, to support deleting the at least one snapshot, the snapshot deletion component 930 may be configured as or otherwise support a means for deleting the expired data that remains in the at least one snapshot after consolidating the expired data with the third data.

In some examples, to support deleting the at least one snapshot, the snapshot deletion component 930 may be configured as or otherwise support a means for deleting, as part of performing the operation, the at least one snapshot based on the at least one snapshot being the full snapshot of the data block in the snapshot chain and based on the full snapshot being the at least one snapshot that is marked for deletion by the user.

In some examples, to support writing the data, the writing component 940 may be configured as or otherwise support a means for writing, for one or more second partitions from among the partitions of the data block, second data associated with the one or more second partitions from one or more third snapshots in the snapshot chain that include a most recent version of the second data in the one or more second partitions to the second snapshot based on the second snapshot satisfying the set of conditions.

In some examples, to support performing the operation, the patch file component 945 may be configured as or otherwise support a means for generating, for snapshots of the snapshot chain that are different than the at least one snapshot that is marked for deletion, respective patch files in a distributed file system, where writing the data includes writing the data between the respective patch files in the distributed file system.

In some examples, subsequent to completion of the operation, the second snapshot includes the new full snapshot in the snapshot chain based on the second snapshot including the most recent version of the data in all of the partitions of the data block. In some examples, the new full snapshot is associated with a most recent version of the partitions of the data block.

In some examples, subsequent to completion of the operation, the snapshot chain includes one or more incremental snapshots that were obtained prior to the second snapshot in time and that include data associated with previous versions of one or more of the partitions of the data block.

FIG. 10 shows a block diagram 1000 of a system 1005 that supports reverse operation for snapshot chains with inline consolidation and garbage collection in accordance with aspects of the present disclosure. The system 1005 may be an example of or include the components of a system 705, a system 805, or a DMS as described herein. The system 1005 may include components for data management, including components such as a reverse operation manager 1020, an input information 1010, an output information 1015, a network interface 1025, at least one memory 1030, at least one processor 1035, and a storage 1040. These components may be in electronic communication or otherwise coupled with each other (e.g., operatively, communicatively, functionally, electronically, electrically: via one or more buses, communications links, communications interfaces, or any combination thereof). Additionally, the components of the system 1005 may include corresponding physical components or may be implemented as corresponding virtual components (e.g., components of one or more virtual machines). In some examples, the system 1005 may be an example of aspects of one or more components described with reference to FIG. 1, such as a DMS 110.

The network interface 1025 may enable the system 1005 to exchange information (e.g., input information 1010, output information 1015, or both) with other systems or devices (not shown). For example, the network interface 1025 may enable the system 1005 to connect to a network (e.g., a network 120 as described herein). The network interface 1025 may include one or more wireless network interfaces, one or more wired network interfaces, or any combination thereof. In some examples, the network interface 1025 may be an example of may be an example of aspects of one or more components described with reference to FIG. 1, such as one or more network interfaces 165.

Memory 1030 may include RAM, ROM, or both. The memory 1030 may store computer-readable, computer-executable software including instructions that, when executed, cause the processor 1035 to perform various functions described herein. In some cases, the memory 1030 may contain, among other things, a basic input/output system (BIOS), which may control basic hardware or software operation such as the interaction with peripheral components or devices. In some cases, the memory 1030 may be an example of aspects of one or more components described with reference to FIG. 1, such as one or more memories 175.

The processor 1035 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1035 may be configured to execute computer-readable instructions stored in a memory 1030 to perform various functions (e.g., functions or tasks supporting reverse operation for snapshot chains with inline consolidation and garbage collection). Though a single processor 1035 is depicted in the example of FIG. 10, it is to be understood that the system 1005 may include any quantity of one or more of processors 1035 and that a group of processors 1035 may collectively perform one or more functions ascribed herein to a processor, such as the processor 1035. In some cases, the processor 1035 may be an example of aspects of one or more components described with reference to FIG. 1, such as one or more processors 170.

Storage 1040 may be configured to store data that is generated, processed, stored, or otherwise used by the system 1005. In some cases, the storage 1040 may include one or more HDDs, one or more SDDs, or both. In some examples, the storage 1040 may be an example of a single database, a distributed database, multiple distributed databases, a data store, a data lake, or an emergency backup database. In some examples, the storage 1040 may be an example of one or more components described with reference to FIG. 1, such as one or more network disks 180.

For example, the reverse operation manager 1020 may be configured as or otherwise support a means for obtaining a full snapshot of a data block and a set of multiple incremental snapshots that include data associated with changes to partitions of the data block since the full snapshot, where the full snapshot and the set of multiple incremental snapshots are stored as a snapshot chain. The reverse operation manager 1020 may be configured as or otherwise support a means for receiving an indication that at least one snapshot of the snapshot chain is marked for deletion by a user. The reverse operation manager 1020 may be configured as or otherwise support a means for performing an operation to reverse an order of the snapshot chain to convert a most recent incremental snapshot in the snapshot chain to a new full snapshot. In some examples, to perform the operation, the reverse operation manager 1020 may be configured as or otherwise support a means for writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and deleting, as part the operation and after writing the data, the at least one snapshot based on the indication that the at least one snapshot is marked for deletion.

By including or configuring the reverse operation manager 1020 in accordance with examples as described herein, the system 1005 may support techniques for reverse operation for snapshot chains with inline consolidation and garbage collection, which may provide one or more benefits such as, for example, improved reliability, reduced latency, improved user experience associated with recovery operations, reduced power consumption, more efficient utilization of computing resources, network resources or both, and improved scalability, among other possibilities.

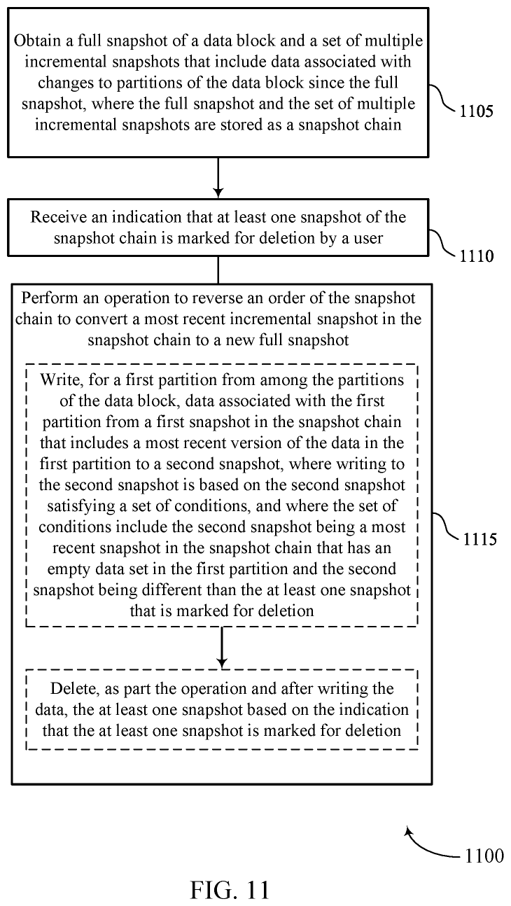

FIG. 11 shows a flowchart illustrating a method 1100 that supports reverse operation for snapshot chains with inline consolidation and garbage collection in accordance with aspects of the present disclosure. The operations of the method 1100 may be implemented by a DMS or its components as described herein. For example, the operations of the method 1100 may be performed by a DMS as described with reference to FIGS. 1 through 10. In some examples, a DMS may execute a set of instructions to control the functional elements of the DMS to perform the described functions. Additionally, or alternatively, the DMS may perform aspects of the described functions using special-purpose hardware.

At 1105, the method may include obtaining a full snapshot of a data block and a set of multiple incremental snapshots that include data associated with changes to partitions of the data block since the full snapshot, where the full snapshot and the set of multiple incremental snapshots are stored as a snapshot chain. The operations of block 1105 may be performed in accordance with examples as disclosed herein. In some examples, aspects of the operations of 1105 may be performed by a snapshot chain component 925 as described with reference to FIG. 9.

At 1110, the method may include receiving an indication that at least one snapshot of the snapshot chain is marked for deletion by a user. The operations of block 1110 may be performed in accordance with examples as disclosed herein. In some examples, aspects of the operations of 1110 may be performed by a snapshot deletion component 930 as described with reference to FIG. 9.

At 1115, the method may include performing an operation to reverse an order of the snapshot chain to convert a most recent incremental snapshot in the snapshot chain to a new full snapshot. In some examples, performing the operation may include writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and deleting, as part the operation and after writing the data, the at least one snapshot based on the indication that the at least one snapshot is marked for deletion. The operations of block 1115 may be performed in accordance with examples as disclosed herein. In some examples, aspects of the operations of 1115 may be performed by a reverse operation component 935 as described with reference to FIG. 9.

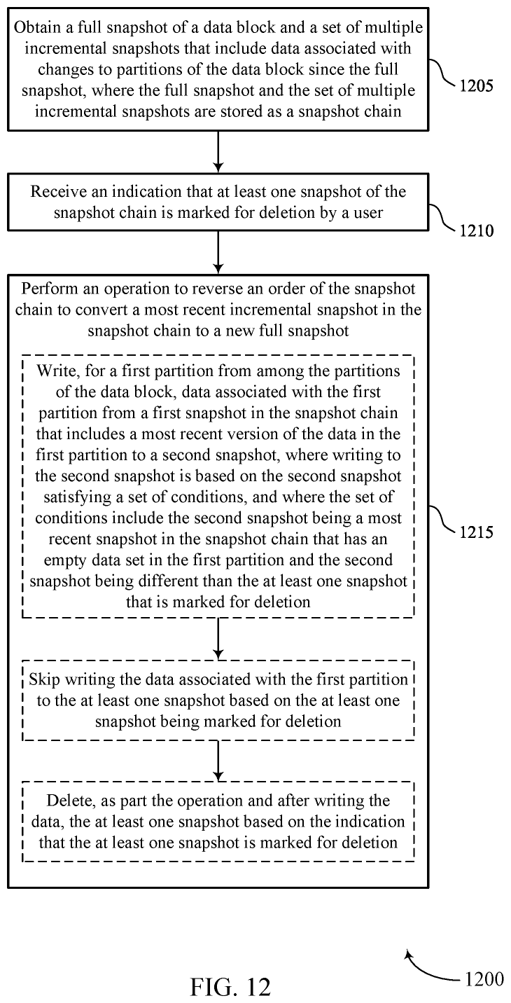

FIG. 12 shows a flowchart illustrating a method 1200 that supports reverse operation for snapshot chains with inline consolidation and garbage collection in accordance with aspects of the present disclosure. The operations of the method 1200 may be implemented by a DMS or its components as described herein. For example, the operations of the method 1200 may be performed by a DMS as described with reference to FIGS. 1 through 10. In some examples, a DMS may execute a set of instructions to control the functional elements of the DMS to perform the described functions. Additionally, or alternatively, the DMS may perform aspects of the described functions using special-purpose hardware.

At 1205, the method may include obtaining a full snapshot of a data block and a set of multiple incremental snapshots that include data associated with changes to partitions of the data block since the full snapshot, where the full snapshot and the set of multiple incremental snapshots are stored as a snapshot chain. The operations of block 1205 may be performed in accordance with examples as disclosed herein. In some examples, aspects of the operations of 1205 may be performed by a snapshot chain component 925 as described with reference to FIG. 9.

At 1210, the method may include receiving an indication that at least one snapshot of the snapshot chain is marked for deletion by a user. The operations of block 1210 may be performed in accordance with examples as disclosed herein. In some examples, aspects of the operations of 1210 may be performed by a snapshot deletion component 930 as described with reference to FIG. 9.

At 1215, the method may include performing an operation to reverse an order of the snapshot chain to convert a most recent incremental snapshot in the snapshot chain to a new full snapshot. In some examples, performing the operation may include writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion, skipping writing the data associated with the first partition to the at least one snapshot based on the at least one snapshot being marked for deletion, and deleting, as part the operation and after writing the data, the at least one snapshot based on the indication that the at least one snapshot is marked for deletion. The operations of block 1215 may be performed in accordance with examples as disclosed herein. In some examples, aspects of the operations of 1215 may be performed by a reverse operation component 935 as described with reference to FIG. 9.

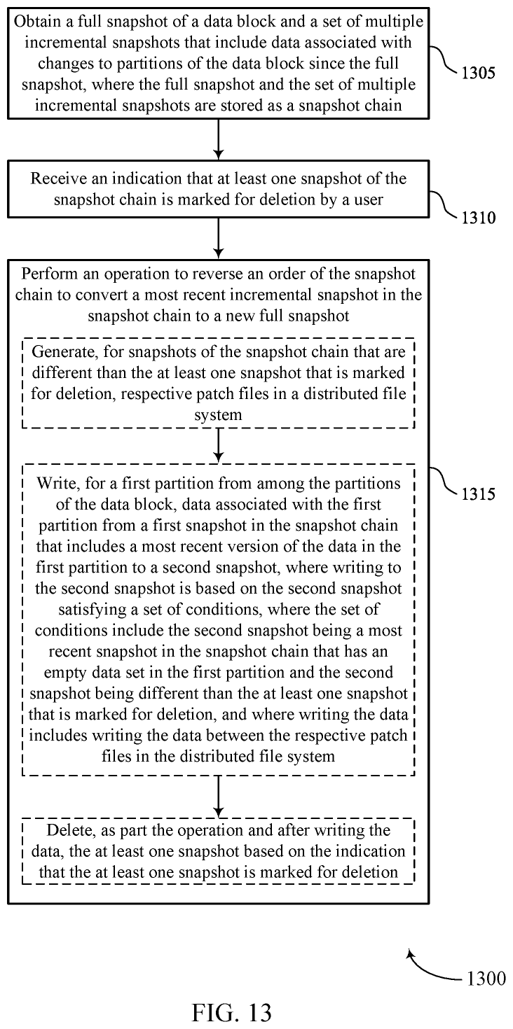

FIG. 13 shows a flowchart illustrating a method 1300 that supports reverse operation for snapshot chains with inline consolidation and garbage collection in accordance with aspects of the present disclosure. The operations of the method 1300 may be implemented by a DMS or its components as described herein. For example, the operations of the method 1300 may be performed by a DMS as described with reference to FIGS. 1 through 10. In some examples, a DMS may execute a set of instructions to control the functional elements of the DMS to perform the described functions. Additionally, or alternatively, the DMS may perform aspects of the described functions using special-purpose hardware.

At 1305, the method may include obtaining a full snapshot of a data block and a set of multiple incremental snapshots that include data associated with changes to partitions of the data block since the full snapshot, where the full snapshot and the set of multiple incremental snapshots are stored as a snapshot chain. The operations of block 1305 may be performed in accordance with examples as disclosed herein. In some examples, aspects of the operations of 1305 may be performed by a snapshot chain component 925 as described with reference to FIG. 9.

At 1310, the method may include receiving an indication that at least one snapshot of the snapshot chain is marked for deletion by a user. The operations of block 1310 may be performed in accordance with examples as disclosed herein. In some examples, aspects of the operations of 1310 may be performed by a snapshot deletion component 930 as described with reference to FIG. 9.

At 1315, the method may include performing an operation to reverse an order of the snapshot chain to convert a most recent incremental snapshot in the snapshot chain to a new full snapshot. In some examples, performing the operation may include generating, for snapshots of the snapshot chain that are different than the at least one snapshot that is marked for deletion, respective patch files in a distributed file system, writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, where the set of conditions include the second snapshot being a most recent snapshot in the snapshot chain that has an empty data set in the first partition and the second snapshot being different than the at least one snapshot that is marked for deletion, and where writing the data includes writing the data between the respective patch files in the distributed file system, and deleting, as part the operation and after writing the data, the at least one snapshot based on the indication that the at least one snapshot is marked for deletion. The operations of block 1315 may be performed in accordance with examples as disclosed herein. In some examples, aspects of the operations of 1315 may be performed by a reverse operation component 935 as described with reference to FIG. 9.

At 1320, the method may include generating, for snapshots of the snapshot chain that are different than the at least one snapshot that is marked for deletion, respective patch files in a distributed file system, where writing the data includes writing the data between the respective patch files in the distributed file system. The operations of block 1320 may be performed in accordance with examples as disclosed herein. In some examples, aspects of the operations of 1320 may be performed by a patch file component 945 as described with reference to FIG. 9.

A method is described. The method may include obtaining a full snapshot of a data block and a set of multiple incremental snapshots that include data associated with changes to partitions of the data block since the full snapshot, where the full snapshot and the set of multiple incremental snapshots are stored as a snapshot chain, receiving an indication that at least one snapshot of the snapshot chain is marked for deletion by a user, and performing an operation to reverse an order of the snapshot chain to convert a most recent incremental snapshot in the snapshot chain to a new full snapshot, where performing the operation includes writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and deleting, as part the operation and after writing the data, the at least one snapshot based on the indication that the at least one snapshot is marked for deletion.

An apparatus is described. The apparatus may include at least one processor, at least one memory coupled with the at least one processor, and instructions stored in the at least one memory. The instructions may be executable by the at least one processor to cause the apparatus to obtain a full snapshot of a data block and a set of multiple incremental snapshots that include data associated with changes to partitions of the data block since the full snapshot, where the full snapshot and the set of multiple incremental snapshots are stored as a snapshot chain, receive an indication that at least one snapshot of the snapshot chain is marked for deletion by a user, and perform an operation to reverse an order of the snapshot chain to convert a most recent incremental snapshot in the snapshot chain to a new full snapshot, where the instructions to perform the operation are executable by the at least one processor to cause the apparatus to write, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and delete, as part the operation and after writing the data, the at least one snapshot based on the indication that the at least one snapshot is marked for deletion.

Another apparatus is described. The apparatus may include means for obtaining a full snapshot of a data block and a set of multiple incremental snapshots that include data associated with changes to partitions of the data block since the full snapshot, where the full snapshot and the set of multiple incremental snapshots are stored as a snapshot chain, means for receiving an indication that at least one snapshot of the snapshot chain is marked for deletion by a user, and means for performing an operation to reverse an order of the snapshot chain to convert a most recent incremental snapshot in the snapshot chain to a new full snapshot, where the means for performing the operation include means for writing, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and means for deleting, as part the operation and after writing the data, the at least one snapshot based on the indication that the at least one snapshot is marked for deletion.

A non-transitory computer-readable medium storing code is described. The code may include instructions executable by a processor to obtain a full snapshot of a data block and a set of multiple incremental snapshots that include data associated with changes to partitions of the data block since the full snapshot, where the full snapshot and the set of multiple incremental snapshots are stored as a snapshot chain, receive an indication that at least one snapshot of the snapshot chain is marked for deletion by a user, and perform an operation to reverse an order of the snapshot chain to convert a most recent incremental snapshot in the snapshot chain to a new full snapshot, where the instructions to perform the operation are executable to write, for a first partition from among the partitions of the data block, data associated with the first partition from a first snapshot in the snapshot chain that includes a most recent version of the data in the first partition to a second snapshot, where writing to the second snapshot is based on the second snapshot satisfying a set of conditions, and where the set of conditions include the second snapshot being a most recent snapshot in the snapshot chain that has an empty data set in the first partition and the second snapshot being different than the at least one snapshot that is marked for deletion and delete, as part the operation and after writing the data, the at least one snapshot based on the indication that the at least one snapshot is marked for deletion.

In some examples of the method, apparatuses, and non-transitory computer-readable medium described herein, performing the operation may include operations, features, means, or instructions for skipping writing the data associated with the first partition to the at least one snapshot based on the at least one snapshot being marked for deletion.

In some examples of the method, apparatuses, and non-transitory computer-readable medium described herein, performing the operation may include operations, features, means, or instructions for writing the data, or second data, or both from the at least one snapshot to the second snapshot or to one or more other snapshots in the snapshot chain, the second data being a most recent version of the second data in one or more respective partitions, where, after writing the data, the second data, or both, the at least one snapshot includes expired data in one or more second partitions based on other data that may be more recent than the expired data being present within the one or more second partitions in other snapshots in the snapshot chain.

In some examples of the method, apparatuses, and non-transitory computer-readable medium described herein, deleting the at least one snapshot may include operations, features, means, or instructions for deleting the expired data.

In some examples of the method, apparatuses, and non-transitory computer-readable medium described herein, performing the operation may include operations, features, means, or instructions for consolidating the expired data in the at least one snapshot with third data in a third snapshot that may be obtained prior to the at least one snapshot in time, where consolidating the expired data includes writing, for a second partition of the partitions of the data block, the expired data that may be in the second partition from the at least one snapshot to the third snapshot based on the third data in the third snapshot including an empty data set in the second partition and skipping writing, for the second partition of the partitions of the data block, the expired data that may be in the second partition from the at least one snapshot to the third snapshot based on the third snapshot including the third data in the second partition.

In some examples of the method, apparatuses, and non-transitory computer-readable medium described herein, deleting the at least one snapshot may include operations, features, means, or instructions for deleting the expired data that remains in the at least one snapshot after consolidating the expired data with the third data.

In some examples of the method, apparatuses, and non-transitory computer-readable medium described herein, deleting the at least one snapshot may include operations, features, means, or instructions for deleting, as part of performing the operation, the at least one snapshot based on the at least one snapshot being the full snapshot of the data block in the snapshot chain and based on the full snapshot being the at least one snapshot that may be marked for deletion by the user.

In some examples of the method, apparatuses, and non-transitory computer-readable medium described herein, writing the data may include operations, features, means, or instructions for writing, for one or more second partitions from among the partitions of the data block, second data associated with the one or more second partitions from one or more third snapshots in the snapshot chain that include a most recent version of the second data in the one or more second partitions to the second snapshot based on the second snapshot satisfying the set of conditions.

In some examples of the method, apparatuses, and non-transitory computer-readable medium described herein, performing the operation may include operations, features, means, or instructions for generating, for snapshots of the snapshot chain that may be different than the at least one snapshot that may be marked for deletion, respective patch files in a distributed file system, where writing the data includes writing the data between the respective patch files in the distributed file system.

In some examples of the method, apparatuses, and non-transitory computer-readable medium described herein, subsequent to completion of the operation, the second snapshot includes the new full snapshot in the snapshot chain based on the second snapshot including the most recent version of the data in all of the partitions of the data block and the new full snapshot may be associated with a most recent version of the partitions of the data block.

In some examples of the method, apparatuses, and non-transitory computer-readable medium described herein, subsequent to completion of the operation, the snapshot chain includes one or more incremental snapshots that were obtained prior to the second snapshot in time and that include data associated with previous versions of one or more of the partitions of the data block.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary.” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining a full snapshot of a data block and a plurality of incremental snapshots that comprise data associated with changes to partitions of the data block since the full snapshot, wherein the full snapshot and the plurality of incremental snapshots are stored as a snapshot chain;
receiving an indication that at least one snapshot of the snapshot chain is marked for deletion by a user; and
performing an operation to reverse an order of the snapshot chain to convert a most recent incremental snapshot in the snapshot chain to a new full snapshot, wherein performing the operation comprises:
writing, for a first partition from among the partitions of the data block, data associated with the first partition from a first snapshot in the snapshot chain that includes a most recent version of the data in the first partition to a second snapshot, wherein writing to the second snapshot is based at least in part on the second snapshot satisfying a set of conditions, and wherein the set of conditions comprise the second snapshot being a most recent snapshot in the snapshot chain that has an empty data set in the first partition and the second snapshot being different than the at least one snapshot that is marked for deletion; and
deleting, as part the operation and after writing the data, the at least one snapshot based at least in part on the indication that the at least one snapshot is marked for deletion.

2. The method of claim 1, wherein performing the operation further comprises:
skipping writing the data associated with the first partition to the at least one snapshot based at least in part on the at least one snapshot being marked for deletion.

3. The method of claim 1, wherein performing the operation further comprises:
writing the data, or second data, or both from the at least one snapshot to the second snapshot or to one or more other snapshots in the snapshot chain, the second data being a most recent version of the second data in one or more respective partitions, wherein, after writing the data, the second data, or both, the at least one snapshot comprises expired data in one or more second partitions based at least in part on other data that is more recent than the expired data being present within the one or more second partitions in other snapshots in the snapshot chain.

4. The method of claim 3, wherein deleting the at least one snapshot comprises:
deleting the expired data.

5. The method of claim 3, wherein performing the operation further comprises:
consolidating the expired data in the at least one snapshot with third data in a third snapshot that is obtained prior to the at least one snapshot in time, wherein consolidating the expired data comprises:
writing, for a second partition of the partitions of the data block, the expired data that is in the second partition from the at least one snapshot to the third snapshot based at least in part on the third data in the third snapshot comprising an empty data set in the second partition; or
skipping writing, for the second partition of the partitions of the data block, the expired data that is in the second partition from the at least one snapshot to the third snapshot based at least in part on the third snapshot comprising the third data in the second partition.

6. The method of claim 5, wherein deleting the at least one snapshot comprises:
deleting the expired data that remains in the at least one snapshot after consolidating the expired data with the third data.

7. The method of claim 1, wherein deleting the at least one snapshot comprises:
deleting, as part of performing the operation, the at least one snapshot based at least in part on the at least one snapshot being the full snapshot of the data block in the snapshot chain and based at least in part on the full snapshot being the at least one snapshot that is marked for deletion by the user.

8. The method of claim 1, wherein writing the data further comprises:
writing, for one or more second partitions from among the partitions of the data block, second data associated with the one or more second partitions from one or more third snapshots in the snapshot chain that include a most recent version of the second data in the one or more second partitions to the second snapshot based at least in part on the second snapshot satisfying the set of conditions.

9. The method of claim 1, wherein performing the operation further comprises:
generating, for snapshots of the snapshot chain that are different than the at least one snapshot that is marked for deletion, respective patch files in a distributed file system, wherein writing the data comprises writing the data between the respective patch files in the distributed file system.

10. The method of claim 1, wherein:
subsequent to completion of the operation, the second snapshot comprises the new full snapshot in the snapshot chain based at least in part on the second snapshot comprising the most recent version of the data in all of the partitions of the data block; and
the new full snapshot is associated with a most recent version of the partitions of the data block.

11. The method of claim 10, wherein subsequent to completion of the operation, the snapshot chain comprises one or more incremental snapshots that were obtained prior to the second snapshot in time and that comprise data associated with previous versions of one or more of the partitions of the data block.

12. An apparatus, comprising:
at least one processor;
at least one memory coupled with the at least one processor; and
instructions stored in the at least one memory and executable by the at least one processor to cause the apparatus to:
obtain a full snapshot of a data block and a plurality of incremental snapshots that comprise data associated with changes to partitions of the data block since the full snapshot, wherein the full snapshot and the plurality of incremental snapshots are stored as a snapshot chain;
receive an indication that at least one snapshot of the snapshot chain is marked for deletion by a user; and
perform an operation to reverse an order of the snapshot chain to convert a most recent incremental snapshot in the snapshot chain to a new full snapshot, wherein the instructions to perform the operation are executable by the at least one processor to cause the apparatus to:
write, for a first partition from among the partitions of the data block, data associated with the first partition from a first snapshot in the snapshot chain that includes a most recent version of the data in the first partition to a second snapshot, wherein writing to the second snapshot is based at least in part on the second snapshot satisfying a set of conditions, and wherein the set of conditions comprise the second snapshot being a most recent snapshot in the snapshot chain that has an empty data set in the first partition and the second snapshot being different than the at least one snapshot that is marked for deletion; and
delete, as part the operation and after writing the data, the at least one snapshot based at least in part on the indication that the at least one snapshot is marked for deletion.

13. The apparatus of claim 12, wherein the instructions to perform the operation are further executable by the at least one processor to cause the apparatus to:
skip writing the data associated with the first partition to the at least one snapshot based at least in part on the at least one snapshot being marked for deletion.

14. The apparatus of claim 12, wherein the instructions to perform the operation are further executable by the at least one processor to cause the apparatus to:
write the data, or second data, or both from the at least one snapshot to the second snapshot or to one or more other snapshots in the snapshot chain, the second data being a most recent version of the second data in one or more respective partitions, wherein, after writing the data, the second data, or both, the at least one snapshot comprises expired data in one or more second partitions based at least in part on other data that is more recent than the expired data being present within the one or more second partitions in other snapshots in the snapshot chain.

15. The apparatus of claim 14, wherein the instructions to perform the operation are further executable by the at least one processor to cause the apparatus to:
consolidate the expired data in the at least one snapshot with third data in a third snapshot that is obtained prior to the at least one snapshot in time, wherein consolidating the expired data comprises:
write, for a second partition of the partitions of the data block, the expired data that is in the second partition from the at least one snapshot to the third snapshot based at least in part on the third data in the third snapshot comprising an empty data set in the second partition; or
skip writing, for the second partition of the partitions of the data block, the expired data that is in the second partition from the at least one snapshot to the third snapshot based at least in part on the third snapshot comprising the third data in the second partition.

16. The apparatus of claim 12, wherein the instructions to delete the at least one snapshot are further executable by the at least one processor to cause the apparatus to:
delete, as part of performing the operation, the at least one snapshot based at least in part on the at least one snapshot being the full snapshot of the data block in the snapshot chain and based at least in part on the full snapshot being the at least one snapshot that is marked for deletion by the user.

17. A non-transitory computer-readable medium storing code, the code comprising instructions executable by a processor to:
obtain a full snapshot of a data block and a plurality of incremental snapshots that comprise data associated with changes to partitions of the data block since the full snapshot, wherein the full snapshot and the plurality of incremental snapshots are stored as a snapshot chain;
receive an indication that at least one snapshot of the snapshot chain is marked for deletion by a user; and
perform an operation to reverse an order of the snapshot chain to convert a most recent incremental snapshot in the snapshot chain to a new full snapshot, wherein the instructions to perform the operation are executable by the processor to:
write, for a first partition from among the partitions of the data block, data associated with the first partition from a first snapshot in the snapshot chain that includes a most recent version of the data in the first partition to a second snapshot, wherein writing to the second snapshot is based at least in part on the second snapshot satisfying a set of conditions, and wherein the set of conditions comprise the second snapshot being a most recent snapshot in the snapshot chain that has an empty data set in the first partition and the second snapshot being different than the at least one snapshot that is marked for deletion; and
delete, as part the operation and after writing the data, the at least one snapshot based at least in part on the indication that the at least one snapshot is marked for deletion.

18. The non-transitory computer-readable medium of claim 17, wherein the instructions to perform the operation are further executable by the processor to:
skip writing the data associated with the first partition to the at least one snapshot based at least in part on the at least one snapshot being marked for deletion.

19. The non-transitory computer-readable medium of claim 17, wherein the instructions to perform the operation are further executable by the processor to:
write the data, or second data, or both from the at least one snapshot to the second snapshot or to one or more other snapshots in the snapshot chain, the second data being a most recent version of the second data in one or more respective partitions, wherein, after writing the data, the second data, or both, the at least one snapshot comprises expired data in one or more second partitions based at least in part on other data that is more recent than the expired data being present within the one or more second partitions in other snapshots in the snapshot chain.

20. The non-transitory computer-readable medium of claim 17, wherein the instructions to delete the at least one snapshot are further executable by the processor to:
delete, as part of performing the operation, the at least one snapshot based at least in part on the at least one snapshot being the full snapshot of the data block in the snapshot chain and based at least in part on the full snapshot being the at least one snapshot that is marked for deletion by the user.
